(19) United States
(12) Patent Application Publication
(10) Pub. No.: US 2024/0097869 A1
(43) Pub. Date: Mar. 21, 2024

(54) METHOD AND DEVICE FOR CARRYING OUT DIGITAL SELF-INTERFERENCE CANCELLATION IN FULL-DUPLEX SYSTEM

(71) Applicant: SAMSUNG ELECTRONICS CO., LTD., Suwon-si, Gyeonggi-do (KR)

(72) Inventors: Kwonjong LEE, Suwon-si (KR); Youngjoon KIM, Suwon-si (KR); Hyojin LEE, Suwon-si (KR); Juho LEE, Suwon-si (KR)

(21) Appl. No.: 18/261,463

(22) PCT Filed: Jan. 12, 2022
(86) PCT No.: PCT/KR2022/000574

§ 371 Date: Jul. 13, 2023

(30) Foreign Application Priority Data
Jan. 15, 2021 (KR) 10-2021-0005773

(51) Int. Cl. H04L 5/14; H04W 56/00

(52) U.S. Cl. CPC H04L 5/1461; H04W 56/001

(57) ABSTRACT

The present disclosure relates to a 5G or 6G communication system for supporting a higher data transmission rate beyond a 4G communication system such as LTE. The present disclosure relates to a method by a transmitting/receiving device, the method enabling: acquiring a time axis digital transmission signal; receiving a reception signal including a self-interference signal; extracting a time axis nonlinear signal sample from the time axis digital transmission signal; converting the time axis digital transmission signal and the time axis nonlinear signal sample into a frequency axis digital transmission signal and a frequency axis nonlinear signal sample; converting the reception signal into a frequency axis digital reception signal; estimating channel information of a self-interference channel, and a nonlinear signal coefficient of the self-interference signal, on the basis of the frequency axis digital transmission signal, the frequency axis nonlinear signal sample and the frequency axis digital reception signal; estimating the self-interference signal on the basis of the channel information and the nonlinear signal coefficient; and carrying out digital self-interference cancellation for the frequency axis digital reception signal by using the self-interference signal.

### TECHNICAL FIELD

The disclosure relates to supporting of a full-duplex operation in a wireless communication system and, more particularly, to a self-interference cancellation scheme for supporting a full-duplex operation and a structure using the same in a wireless communication system.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DETAILED DESCRIPTION OF THE INVENTION

### Technical Problem

The disclosure provides a method and an apparatus for transmitting and receiving a signal by a transmission/reception device supporting a full-duplex operation in a wireless communication on the basis of the discussion.

Further, the disclosure provides a method and an apparatus for cancelling self-interference by a transmission/reception device supporting a full-duplex operation in a wireless communication system.

### Technical Solution

A method of performing digital self-interference cancellation by a transmission/reception device including a transmitting side and a receiving side in a full-duplex system according to an embodiment of the disclosure includes acquiring a time axis digital transmission signal generated by the transmitting side, receiving a reception signal including a self-interference signal received through a self-interference channel between the transmitting side and the receiving side through the receiving side, extracting at least one time axis non-linear signal sample for estimating the self-interference channel and at least one non-linear signal coefficient of the self-interference signal from the time axis digital transmission signal, converting the time axis digital transmission signal into a frequency axis digital transmission signal and the at least one time axis non-linear signal sample into at least one frequency axis non-linear signal sample, converting the reception signal into a frequency axis digital reception signal, estimating channel information of the self-interference channel and at least one non-linear signal coefficient of the self-interference signal, based on the frequency axis digital transmission signal, the at least one frequency axis non-linear signal sample, and the frequency axis digital reception signal, estimating the self-interference signal, based on the estimated channel information and the estimated at least one non-linear signal coefficient, and performing digital self-interference cancellation for the frequency axis digital reception signal by using the estimated self-interference signal.

The method of performing digital self-interference cancellation by the transmission/reception device including the transmitting side and the receiving side in the full-duplex system according to another embodiment of the disclosure further includes analyzing multiple paths of the reception signal, comparing a number of the analyzed multiple paths with a threshold value, and in case that the number of the analyzed multiple paths is greater than or equal to the threshold value, converting the time axis digital transmission signal into the frequency axis digital transmission signal and the at least one time axis non-linear signal sample into at least one frequency axis non-linear signal sample.

The method of performing digital self-interference cancellation by the transmission/reception device including the transmitting side and the receiving side in the full-duplex system according to another embodiment of the disclosure further includes updating the at least one non-linear signal coefficients for the estimated self-interference signal, comparing a strength of a signal obtained by attenuating the estimated self-interference signal from the frequency axis digital reception signal with a threshold value, in case that the strength of the signal obtained by attenuating the estimated self-interference signal from the frequency axis digital reception signal is greater than or equal to the threshold value, estimating at least one non-linear signal coefficient for the signal obtained by attenuating the estimated self-interference signal from the frequency axis digital reception signal, and in case that the strength of the signal obtained by attenuating the estimated self-interference signal from the frequency axis digital reception signal is less than the threshold value, estimating the self-interference signal, based on the estimated self-interference channel and the updated non-linear signal coefficient and performing the digital self-interference cancellation for the frequency axis digital reception signal by using the estimated self-interference signal.

The method of performing digital self-interference cancellation by the transmission/reception device including the transmitting side and the receiving side in the full-duplex system according to another embodiment of the disclosure further includes comparing a strength of a signal obtained by attenuating the estimated self-interference signal from the frequency axis digital reception signal with a threshold value, in case that the strength of the signal obtained by attenuating the estimated self-interference signal from the frequency axis digital reception signal is greater than or equal to the threshold value, adjusting a number of the non-linear signal coefficients and estimating the self-interference signal, based on the adjusted number of the non-linear signal coefficients, and in case that the strength of the signal obtained by attenuating the estimated self-interference signal from the frequency axis digital reception signal is less than the threshold value, performing the digital self-interference cancellation for the frequency axis digital reception signal by using the estimated self-interference signal.

The method of performing digital self-interference cancellation by the transmission/reception device including the transmitting side and the receiving side in the full-duplex system according to another embodiment of the disclosure further includes correcting a time synchronization error for the time axis digital transmission signal.

The method of performing digital self-interference cancellation by the transmission/reception device including the transmitting side and the receiving side in the full-duplex system according to another embodiment of the disclosure further includes configuring an initial value of a time offset as 0, converting the reception signal into a time axis digital reception signal, performing a convolution operation for signals delayed from the time axis digital reception signal and the time axis digital transmission signal by the time offset, comparing a result of the convolution operation for the signals delayed from the time axis digital reception signal and the time axis digital transmission signal by the time offset with a result of the convolution operation for signals delayed. from the time axis digital reception signal and the time axis digital transmission signal by a value less than the time offset by 1, in case that the result of the convolution operation for the signals delayed from the time axis digital reception signal and the time axis digital transmission signal by the time offset is greater than the result of the convolution operation for signals delayed from the time axis digital reception signal and the time axis digital transmission signal by the value less than the time offset by 1, increasing the time offset by 1 and comparing a result of the convolution operation for signals delayed from the time axis digital reception signal and the time axis digital transmission signal by a value increased from the time offset by 1 with a result of the convolution operation for signals delayed from the time axis digital reception signal and the time axis digital transmission signal by the time offset, and in case that the result of the convolution operation for the signals delayed from the time axis digital reception signal and the time axis digital transmission signal by the time offset is less than the result of the convolution operation for signals delayed from the time axis digital reception signal and the time axis digital transmission signal by the value less than the time offset by 1, configuring the value less than the time offset by 1 as a time synchronization error value and correcting the time synchronization error for the time axis digital transmission signal by using the configured time synchronization error value.

The method of performing digital self-interference cancellation by the transmission/reception device including the transmitting side and the receiving side in the full-duplex system according to another embodiment of the disclosure further includes configuring an initial value of a time offset as 0, converting the reception signal into a time axis digital reception signal, performing a convolution operation for signals delayed from the time axis digital reception signal and the time axis digital transmission signal by the time offset, storing a result of the convolution operation for the signals delayed from the time axis digital reception signal and the time axis digital transmission signal by the time offset, comparing the time offset and a value corresponding to a total number of samples for the time axis digital transmission signal, in case that the time offset is less than the value corresponding to the total number of samples for the time axis digital transmission signal, increasing the time offset by 1. performing the convolution operation for signals delayed from the time axis digital reception signal and the time axis digital transmission signal by a value increased from the time offset by 1, and storing a result of the convolution operation for the signals delayed from the time axis digital reception signal and the time axis digital transmission signal by the value increased from the time offset by 1, and in case that the time offset is greater than the value corresponding to the total number of samples for the time axis digital transmission signal, configuring a time offset value corresponding to an operation result having a maximum value among stored at least one operation result as a time synchronization error value and correcting the time synchronization error for the time axis digital transmission signal by using the configured time synchronization error value.

The method of performing digital self-interference cancellation by the transmission/reception device including the transmitting side and the receiving side in the full-duplex system according to another embodiment of the disclosure further includes determining whether a time synchronization signal is included in the reception signal, in case that the time synchronization signal is included in the reception signal, correcting a time synchronization error of the reception signal by using the time synchronization signal, and in case that the time synchronization signal is not included in the reception signal, correcting the time synchronization error of the reception signal by using a data signal included in the reception signal.

The method of performing digital self-interference cancellation by the transmission/reception device including the transmitting side and the receiving side in the full-duplex system according to another embodiment of the disclosure further includes converting the reception signal into a time axis digital reception signal, approximating the time axis digital reception signal as a polynomial for the time axis digital transmission signal, and configuring respective terms of the approximated polynomial as the at least one time axis non-linear signal samples.

The method of performing digital self-interference cancellation by the transmission/reception device including the transmitting side and the receiving side in the full-duplex system according to another embodiment of the disclosure further includes, in case that the frequency axis digital reception signal is approximated as a polynomial for the frequency axis digital transmission signal, the non-linear coefficients are correlated to at least one term of the approximated polynomial.

A transmission/reception apparatus performing digital self-interference cancellation in a full-duplex system according to an embodiment of the disclosure includes a transmitter, a receiver, and a controller configured to acquire a time axis digital transmission signal generated by the transmitter, control the receiver to receive a reception signal including a self-interference signal received through a self-interference channel between the transmitter and the receiver through the receiver, extract at least one time axis non-linear signal sample for estimating the self-interference channel and at least one non-linear signal coefficient of the self-interference signal from the time axis digital transmission signal, convert the time axis digital transmission signal into a frequency axis digital transmission signal and the at least one time axis non-linear signal sample into at least one frequency axis non-linear signal sample, convert the reception signal into a frequency axis digital reception signal and estimate channel information of the self-interference channel and at least one non-linear signal coefficient of the self-interference signal, based on the frequency axis digital transmission signal, the at least one frequency axis non-linear signal sample, and the frequency axis digital reception signal, estimate the self-interference signal, based on the estimated channel information and the estimated at least one non-linear signal coefficient, and perform digital self-interference cancellation for the frequency axis digital reception signal by using the estimated self-interference signal.

The transmission/reception apparatus performing digital self-interference cancellation in the full-duplex system according to another embodiment of the disclosure includes the controller configured to analyze multiple paths of the reception signal, compare a number of the analyzed multiple paths with a threshold value, and in case that the number of the analyzed multiple paths is greater than or equal to the threshold value, convert the time axis digital transmission signal into the frequency axis digital transmission signal and the at least one time axis non-linear signal sample into at least one frequency axis non-linear signal sample.

The transmission/reception apparatus performing digital self-interference cancellation in the full-duplex system according to another embodiment of the disclosure includes the controller configured to update the at least one non-linear signal coefficients for the estimated self-interference signal, compare a strength of a signal obtained by attenuating the estimated self-interference signal from the frequency axis digital reception signal with a threshold value, in case that the strength of the signal obtained by attenuating the estimated self-interference signal from the frequency axis digital reception signal is greater than or equal to the threshold value, estimate at least one non-linear signal coefficient for the signal obtained by attenuating the estimated self-interference signal from the frequency axis digital reception signal, and in case that the strength of the signal obtained by attenuating the estimated self-interference signal from the frequency axis digital reception signal is less than the threshold value, estimate the self-interference signal, based on the estimated self-interference channel and the updated non-linear signal coefficient and performing the digital self-interference cancellation for the frequency axis digital reception signal by using the estimated self-interference signal.

The transmission/reception apparatus performing digital self-interference cancellation in the full-duplex system according to another embodiment of the disclosure includes the controller configured to compare a strength of a signal obtained by attenuating the estimated self-interference signal from the frequency axis digital reception signal with a threshold value, in case that the strength of the signal obtained by attenuating the estimated self-interference signal from the frequency axis digital reception signal is greater than or equal to the threshold value, adjust a number of the non-linear signal coefficients and estimating the self-interference signal, based on the adjusted number of the non-linear signal coefficients, and in case that the strength of the signal obtained by attenuating the estimated self-interference signal from the frequency axis digital reception signal is less than the threshold value, perform the digital self-interference cancellation for the frequency axis digital reception signal by using the estimated self-interference signal.

The transmission/reception apparatus performing digital self-interference cancellation in the full-duplex system according to another embodiment of the disclosure includes the controller configured to correct a time synchronization error for the time axis digital transmission signal.

The transmission/reception apparatus performing digital self-interference cancellation in the full-duplex system according to another embodiment of the disclosure includes the controller configured to configure an initial value of a time offset as 0, convert the reception signal into a time axis digital reception signal, perform a convolution operation for signals delayed from the time axis digital reception signal and the time axis digital transmission signal by the time offset, compare a result of the convolution operation for the signals delayed from the time axis digital reception signal and the time axis digital transmission signal by the time offset with a result of the convolution operation for signals delayed from the time axis digital reception signal and the time axis digital transmission signal by a value less than the time offset by 1, in case that the result of the convolution operation for the signals delayed from the time axis digital reception signal and the time axis digital transmission signal by the time offset is greater than the result of the convolution operation for signals delayed from the time axis digital reception signal and the time axis digital transmission signal by the value less than the time offset by 1, increase the time offset by 1 and compare a result of the convolution operation for signals delayed from the time axis digital reception signal and the time axis digital transmission signal by a value increased from the time offset by 1 with a result of the convolution operation for signals delayed from the time axis digital reception signal and the time axis digital transmission signal by the time offset, and in case that the result of the convolution operation for the signals delayed from the time axis digital reception signal and the time axis digital transmission signal by the time offset is less than the result of the convolution operation for signals delayed from the time axis digital reception signal and the time axis digital transmission signal by the value less than the time offset by 1, configure the value less than the time offset by 1 as a time synchronization error value and correct the time synchronization error for the time axis digital transmission signal by using the configured time synchronization error value.

The transmission/reception apparatus performing digital self-interference cancellation in the full-duplex system according to another embodiment of the disclosure includes the controller configured to configure an initial value of a time offset as 0, convert the reception signal into a time axis digital reception signal, perform a convolution operation for signals delayed from the time axis digital reception signal and the time axis digital transmission signal by the time offset, store a result of the convolution operation for the signals delayed from the time axis digital reception signal and the time axis digital transmission signal by the time offset, compare the time offset and a value corresponding to a total number of samples for the time axis digital transmission signal, in case that the time offset is less than the value corresponding to the total number of samples for the time axis digital transmission signal, increase the time offset by 1, perform the convolution operation for signals delayed from the time axis digital reception signal and the time axis digital transmission signal by a value increased from the time offset by 1, and store a result of the convolution operation for the signals delayed from the time axis digital reception signal and the time axis digital transmission signal by the value increased from the time offset by 1, and in case that the time offset is greater than the value corresponding to the total number of samples for the time axis digital transmission signal, configure a time offset value corresponding to an operation result having a maximum value among stored at least one operation result as a time synchronization error value and correct the time synchronization error for the time axis digital transmission signal by using the configured time synchronization error value.

The transmission/reception apparatus performing digital self-interference cancellation in the full-duplex system according to another embodiment of the disclosure includes the controller configured to determine whether a time synchronization signal is included in the reception signal, in case that the time synchronization signal is included in the reception signal, correct a time synchronization error of the reception signal by using the time synchronization signal, and in case that the time synchronization signal is not included in the reception signal, correct the time synchronization error of the reception signal by using a data signal included in the reception signal.

The transmission/reception apparatus performing digital self-interference cancellation in the full-duplex system according to another embodiment of the disclosure includes the controller configured to convert the reception signal into a time axis digital reception signal, approximate the time axis digital reception signal as a polynomial for the time axis digital transmission signal, and configure respective terms of the approximated polynomial as the at least one time axis non-linear signal samples.

In the transmission/reception apparatus performing digital self-interference cancellation in the full-duplex system according to another embodiment of the disclosure, in case that the frequency axis digital reception signal is approximated as a polynomial for the frequency axis digital transmission signal, the non-linear coefficients are correlated to at least one term of the approximated polynomial.

### BRIEF DESCRIPTION OF DRAWINGS

FIG. 1 illustrates the basic structure f time-frequency domains which are radio resource areas in which data or control channels are transmitted in an LTE system.

FIG. 2 illustrates a PDCCH, which is a downlink physical channel through which DCI is transmitted in the UTE system.

FIG. 3 illustrates an example of the basic unit of time and frequency resources included in a downlink control channel in a 5G system.

FIG. 4 illustrates an example of a control region (control resource set (CORESET)) in which a downlink control channel is transmitted in the 5G system.

FIG. 5 illustrates an example of a configuration for the downlink RB structure in the 5G system.

FIG. 6 illustrates a configuration of a transmission/reception device having a self-interference cancellation function in the full-duplex system according to an embodiment of the disclosure.

FIG. 7 illustrates a configuration of the self-interference cancellation unit according to an embodiment of the disclosure.

FIG. 8 illustrates the flow of a transmission signal generated by a transmitting side according to an embodiment of the disclosure.

FIG. 9 illustrates the flow of a reception signal generated by the receiving side according to an embodiment of the disclosure.

FIG. 10 illustrates the structure of a transceiver for performing the conventional digital self-interference cancellation.

FIG. 11 illustrates multi-panel structures of the transmitting side and the receiving side.

FIG. 12 illustrates a method of performing time axis self-interference cancellation in a full-duplex operation according to an embodiment of the disclosure.

FIG. 13 illustrates the structure of the transceiver for performing time axis digital self-interference cancellation according to an embodiment of the disclosure.

FIG. 14 illustrates a method of performing frequency axis self-interference cancellation in the full-duplex operation according to an embodiment of the disclosure.

FIG. 15 illustrates the structure of the transceiver for performing frequency axis digital self-interference cancellation according to an embodiment of the disclosure.

FIG. 16 illustrates a time synchronization error between a digital transmission signal of the transmitting side and a digital reception signal of the receiving side according to an embodiment of the disclosure.

FIG. 17 illustrates a method of correcting a time synchronization error due to a channel delay by using the correlation between the reception signal and the transmission signal according to an embodiment of the disclosure.

FIG. 18 illustrates a method of connecting the time synchronization error due to the channel delay by using the correlation between the reception signal and the transmission signal according to another embodiment of the disclosure.

FIG. 19 illustrates a state of the receiving side performing channel delay estimation according to whether a self-interference signal includes a synchronization signal according to an embodiment of the disclosure.

FIG. 20 illustrates a method of correcting the time synchronization error due to the channel delay of the reception signal and the transmission signal according to an embodiment of the disclosure.

FIG. 21 illustrates a method of performing time axis digital self-interference cancellation and frequency axis digital self-interference cancellation in consideration of multiple paths according to an embodiment of the disclosure.

FIG. 22 illustrates a method of performing the digital self-interference cancellation again according to an embodiment of the disclosure.

FIG. 23 illustrates the method of performing digital self-interference cancellation again according to another embodiment of the disclosure.

FIG. 24 illustrates a configuration of the transmitting side and the receiving side within the same node according to an embodiment of the disclosure.

FIG. 25 illustrates a connection structure between the transmitting side and the receiving side within the same node according to an embodiment of the disclosure.

FIG. 26 illustrates the connection structure between the transmitting side and the receiving side within the same node according to another embodiment of the disclosure.

FIG. 27 illustrates the connection structure between the preprocessor, the transmitting side, and the receiving side according to an embodiment of the disclosure.

FIG. 28 illustrates the connection structure between the preprocessor, the transmitting side, and the receiving side according to another embodiment of the disclosure.

FIG. 29 illustrates the connection structure between the preprocessor, the transmitting side, and the receiving side according to another embodiment of the disclosure.

FIG. 30 illustrates the connection structure between the preprocessor, the transmitting side, and the receiving side according to another embodiment of the disclosure.

FIG. 31 illustrates the internal structure of the preprocessor according to an embodiment of the disclosure.

### MODE FOR CARRYING OUT THE INVENTION

Hereinafter, embodiments of the disclosure will be described in detail with reference to the accompanying drawings.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a less number of elements, or a “unit”, or divided into a greater number of elements, or a “unit”. Moreover, the elements and “units” or may be implemented to reproduce one or more CPUs within a device or a security multimedia card. Furthermore, the “unit” in the embodiments may include one or more processors.

Hereinafter, the operation principle of the disclosure will be described in detail with reference to the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification. In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. Of course, examples of the base station and the terminal are not limited thereto. In the following description of the disclosure, a technology for receiving broadcast information by a terminal in a wireless communication system will be described. The disclosure relates to 5th generation (5G) or 6th generation (5G) communication systems for supporting a higher data transfer rate beyond 4th generation (4G) systems. The disclosure may be applied to intelligent services (e.g., smart homes, smart buildings, smart cities, smart cars or connected cars, healthcare, digital education, retail business, security- and safety-related services, etc.) on the basis of 5G communication technology and IoT-related technology, and may be further applied to truly immersive extended reality, high-fidelity mobile hologram, digital replica, etc. related to the 6G communication system technology.

In the following description, terms referring to broadcast information, terms referring to control information, terms related to communication coverage, terms referring to state changes (e.g., event), terms referring to network entities, terms referring to messages, terms referring to device elements, and the like are illustratively used for the sake of descriptive convenience. Therefore, the disclosure is not limited by the terms as used below, and other terms referring to subjects having equivalent technical meanings may be used.

In the following description, some of terms and names defined in in the 3rd generation partnership project long term evolution (3GPP LTE) standards may be used for the sake of descriptive convenience. However, the disclosure is not limited by these terms and names, and may be applied in the same way to systems that conform other standards.

A wireless communication system is advancing to a broadband wireless communication system for providing high-speed and high-quality packet data services using communication standards, such as high-speed packet access (HSPA) of 3GPP, LTE {long-term evolution or evolved universal terrestrial radio access (E-UTRA)}, LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) (or a mobile station (MS)) transmits data or control signals to a base station (BS) (generation Node B (gNB) or eNode B (eNB)), and the downlink indicates a radio link through which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a post-LTE communication system, that is, 5G communication system must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, raMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also requires a design for assigning a large number of resources in a frequency band in order to secure reliability of a communication link. However, the above-described mMTC, URLLC, and eBB are merely an example of different service types, and services types to which the disclosure is applied are not limited thereto.

The above-described services considered in the 5G communication system must be converged with each other so as to be provided based on one framework. That is, the respective services are preferably integrated into a single system and controlled and transmitted in the integrated single system, instead of being operated independently, for efficient resource management and control.

Furthermore, in the following description of embodiments of the disclosure, an LTE, LTE-A, LTE-Pro, or NR system will be described by way of example, but the embodiments of the disclosure may be applied to other communication systems having similar backgrounds or channel types. In addition, based on determinations by those skilled in the art, the embodiments of the disclosure may be applied to other communication systems through some modifications without significantly departing from the scope of the disclosure.

Hereinafter, the frame structure of the LTE and LTE-A systems will be described in more detail with reference to the drawings.

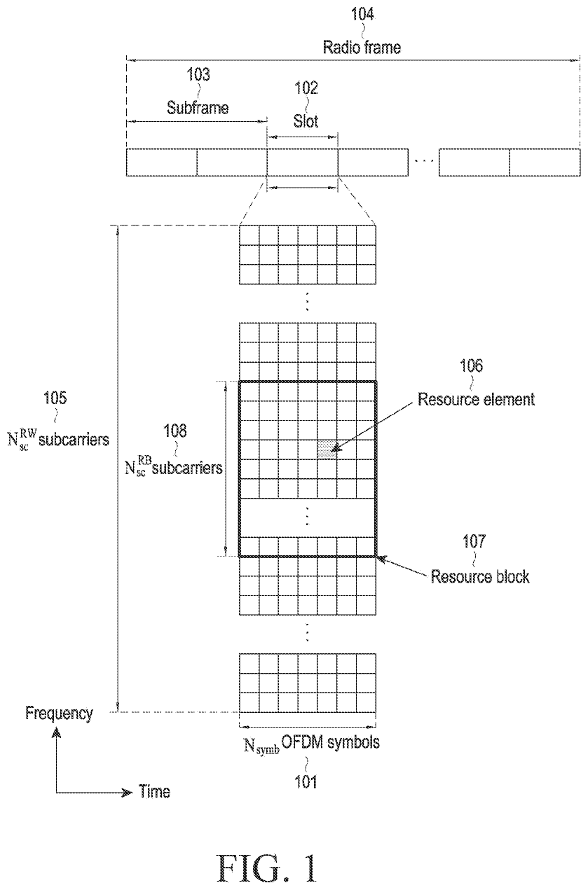

FIG. 1 illustrates the basic structure of time-frequency domains which are radio resource areas in which data and/or control channels are transmitted in the LTE system.

In FIG. 1, the horizontal axis indicates the time domain, and the vertical axis indicates the frequency domain. The minimum transmission unit in the time domain is an OFDM symbol. One slot 102 includes N_{symb} OFDM symbols 101 and one subframe 103 includes 2 slots. The length of the slot 102 is 0.5 ins and the length of the subframe 103 is 0.1 ms. A radio frame 104 is a time-domain unit including 10 subframes. The minimum transmission unit in the frequency domain is a subcarrier 105. The entire system transmission bandwidth may include a total of N_{BW} subcarriers 105.

The basic resource unit in the time-frequency domain is a resource element (RE) 106, and an RE is expressed by an OFDM symbol index and a subcarrier index. A resource block (RB or physical resource block (PRB)) 107 is defined by N_{symb} successive OFDM symbols 101 in the time domain and N_{RB} successive subcarriers 108 in the frequency domain. Therefore, one RB 107 includes N_{symb}×N_{RB} REs 106. Generally, the minimum transmission unit of data is the RB. In the LTE system, generally, N_{symb}=7 and N_{RB}=12. N_{BW} and N_{RB} are proportional to the bandwidth of the system transmission band.

Below, downlink control information (DCI) in the LTE and LTE-A systems will be described in more detail.

In the LTE system, scheduling information of downlink data or uplink data is transmitted from the base station (BS) to a user equipment CUE) through the DCI. The DCI may include information indicating scheduling information is scheduling information for uplink data or downlink data, whether the DCI is compact DCI having small size control information, whether spatial multiplexing using multiple antennas is applied, and the DCI is DCI for controlling power. Further, DCI formats defined according to the information may be applied and operated. For example, DCI format 1, which is scheduling information of downlink data, may include the following control information.
Resource allocation type 0/1 flag: notifies whether a resource allocation type is type 0 or type 1. Type 0 applies a bitmap scheme and allocates resources in the unit of resource block groups (RBG). In the LTE system, a basic scheduling unit is a resource block (RB) expressed by time and frequency domain resources, and an RBG includes a plurality of RBs and is a basic scheduling unit in the type 0 scheme. Type 1 allows allocation of predetermined RBs in an RBG.
Resource block assignment: indicates RBs allocated to data transmission. Expressed resources are determined according to the system bandwidth and the resource allocation type.
   Modulation and coding scheme (MCS): indicates the modulation scheme used for data transmission and the size of the transport block, that is, the data to be transmitted.
HARQ process number: indicates a process number of HARQ.
New data indicator: indicates HARQ initial transmission or HARQ retransmission.
Redundancy version: indicates a redundancy version of HARQ.
Transmit power control (TPC) command for physical uplink control channel (PUCCH): indicates a transmission power control command for a PUCCH, which is an uplink control channel.

The DCI is transmitted through a physical downlink control channel (PDCCH) corresponding to a downlink physical control channel via a channel coding and modulation process.

A cyclic redundancy check (CRC) is added to a DCI message payload and is scrambled with a radio network temporary identifier (RNTI) corresponding to the identity of the UE. Depending on the purpose of the DCI message, for example, UE-specific data transmission, a power control command, or a random access response, different RNTIs are used. The RNTI is not explicitly transmitted, but is transmitted in the state of being included in a CRC calculation process. When the DCI message transmitted to the PDCCH is received, the terminal may identify the CRC through the allocated RNTI, and may recognize that the corresponding message is transmitted to the UE when the CRC is determined to be correct on the basis of the CRC identification result.

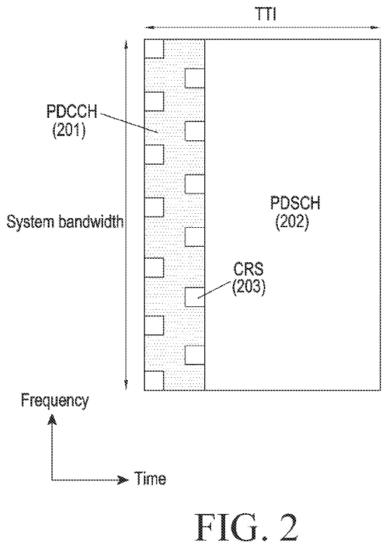

FIG. 2 illustrates a PDCCH, which is a downlink physical channel through Which DCI is transmitted in the LTE system.

Referring to FIG. 2, a PDCCH 201 is time-multiplexed with a physical downlink shared channel (PDSCH) 202, which is a data transmission channel, and is transmitted over the entire system bandwidth. A region of the PDCCH 201 is expressed by the number of OFDM symbols, and is indicated to the UE through a control format indicator (CFI) transmitted through a physical control format indicator channel (PCFICH).

By allocating the PDCCH 201 to OFDM symbols on the front part of the subframe, the UE may decode downlink scheduling allocation as soon as possible, and thus a decoding delay for a downlink shared channel (DL-SCH), that is, an entire downlink transmission delay, may be reduced.

One PDCCH carries one DCI message, and a plurality of UEs may be simultaneously scheduled in the downlink and the uplink, so that transmission of a plurality of PDCCHs is simultaneously performed within each cell. A cell-specific reference signal (CRS) 203 is used as a reference signal for decoding the PDCCH 201. The CRS 203 is transmitted in every subframe over the entire band, and scrambling and resource mapping vary depending on a cell identity (ID). Since the CRS 203 is a reference signal used in common by all UEs, UE-specific beamforming cannot be used. Accordingly, a multi-antenna transmission scheme for the PDCCH in LTE is limited to open-loop transmission diversity. The number of ports of the CRS is implicitly made known to the UE from decoding of a physical broadcast channel (PBCH).

Resource allocation of the PDCCH 201 is based on a control-channel element (CCE), and one CCE includes 9 resource element groups (REGs), that is, a total of 36 resource elements (REs). The number of CCEs required for a particular PDCCH 201 may be 1, 2, 4, or 8, which varies depending on the channel-coding rate of the DCI message payload. As described above, a different numbers of CCEs may be used to implement link adaptation of the PDCCH 201.

The UE is required to detect a signal while the UE is not aware of information on the PDCCH 201, so a search space indicating a set of CCEs is defined for blind decoding in LTE. The search space includes a plurality of sets at an aggregation level (AL) of each CCE, which is not explicitly signaled but is implicitly defined through a function using a UE identity and a subframe number. In each subframe, the terminal performs decoding on the PDCCH 201 with respect to all resource candidates that can be configured by CCEs within the set search space and processes information declared to be valid to the corresponding terminal through identification of the CRC.

The search space is divided into a UE-specific search space and a common search space. UEs in a predetermined group or all UEs may search for a common search space of the PDCCH 201 in order to receive cell-common control information such as dynamic scheduling of system information or paging messages. For example, scheduling allocation information of the DL-SCH for transmission of system information block (SIB)-1 including service provider information of the cell may be received by searching for the common search space of the PDCCH 201.

In LTE, the entire PDCCH region includes a set of CCEs in a logical area and there is a search space including the set of CCEs. The search space is classified into a common search space and a UE-specific search space, and the search space for the LTE PDCCH is defined as follows.

```
  The set of PDCCH candidates to monitor are defined in terms of
search spaces, where a search space Sₖ^{(L)} at aggregation level L ∈
{1,2,4,8} is defined by a set of PDCCH candidates. For each serving cell
on which PDCCH is monitored. the CCEs corresponding to PDCCH
candidate m of the search space Sₖ^{(L)} are given by
  L {(Yₖ + m′)mod└N_{CC} [symbol] ₖ / L┘}+ [symbol]
  where Yₖ is defined below, i = 0,...,L −1 . For the common search
space m′ = m . For the PDCCH UE specific search space, for the serving
cell on which PDCCH is monitored, if the monitoring UE is configured
with carrier indicator field then m′ = m + M^{(L)} · n_{CI} where n_{CI} is the
carrier indicator field value, else if the monitoring UE is not configured
with carrier indicator field then m′ = m , where m = 0,...,M^{(L)} −1 . M^{(L)}
is the number of PDCCH candidates to monitor in the given search space.
  Note that the carrier indicator field value is the same as
ServCellIndex
  For the common search spaces, Yₖ is set to 0 for the two aggregation
levels L = 4 and L = 8 .
  For the UE-specific search space Sₖ^{(L)} at aggregation level L , the
variable Yₖ is defined by
    Yₖ = (A·Yₖ₋₁)modD
  where Y₋₁ = n_{RNTI} ≠ 0 , A = 39827 , D = 65537 and k = └n [symbol] /2┘ ,
n [symbol]  is the slot number within a radio frame. The RNTI value used for
n_{RNTI} is defined in Subclause 7.1 in downlink and subclause 8 in uplink. [symbol]
indicates data missing or illegible when filed
```

According to the definition of the search space for the PDCCH, the UE-specific search space is not explicitly signaled, but is implicitly defined through a function by a UE identity and a subframe, number. That is, the UE-specific search space is changeable according to a subframe number, which means that the UE-specific search space is changeable according to the time. Thereby, a problem (defined as a blocking problem) between UEs in which a particular UE cannot use a search space due to other UEs is solved.

According to an embodiment, if no UE can be scheduled in the corresponding subframe since all CCEs for which a specific UE searches have already been used by other UEs scheduled within the same subframe, the search space is changed according to the time and thus this problem may not occur in the subsequent subframe. For example, even though terminal-specific search spaces of terminal #1 and terminal #2 partially overlap each other in a particular subframe, the terminal-specific search space is changed according to the subframe, and thus it may be expected that overlapping in the subsequent subframe will be different.

According to the definition of the search space for the PDCCH, since terminals in a predetermined group or all terminals should receive the PDCCH, the common search space is defined as a pre-appointed set of CCEs. That is, the common search space is not changed according to the UE identity or the subframe number. Although the common search space exists for transmission of various system messages, the common search space may also be used for individual transmission of control information of the UE. Accordingly, the common search space may be used to solve the problem in which resources available in the terminal-specific search space are insufficient and thus terminals cannot be scheduled.

The search space is a set of candidate control channels including CCEs for which the UE should attempt decoding at the given aggregation level, and there are several aggregation levels at which a set of CCEs is configured by 1, 2, 4, and 8 CCEs, so that the UE has a plurality of search spaces. The number of PDCCH candidates which the UE should monitor within the search space according to the aggregation level in the LTE PDCCH is defined as shown in the following table.

TABLE 1

| Search space Sₖ^{(L)} | | | Number |
|---|---|---|---|
| | Aggregation | Size | of PDCCH |
| Type | level L | [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

According to [Table 1], in the UE-specific search space, aggregation levels {1, 2, 4, 8} are supported in which case {6, 6, 2, 2} PDCCH candidates exist, respectively. In the common search space, aggregation levels {4, 8} are supported in which case {4, 2} PDCCH candidates exist, respectively. The reason why the common search space supports only aggregation levels 4 and 8 is that coverage characteristics are generally good when a system message reaches a cell edge.

DCI transmitted to the common search space is defined only for a system message or a particular DCI format, such as 0/1A/3/3A/1C, corresponding to the purpose of power control for a terminal group. Within the common search space, a DCI format having spatial multiplexing is not supported. A downlink DCI format, which should be decoded in the terminal-specific search space, varies depending on the transmission mode configured for the corresponding terminal. Since the configuration of the transmission mode is performed through radio resource control (RRC) signaling, a subframe number indicating whether the corresponding configuration is valid for the corresponding UE is not accurately specified. Accordingly, the UE may operate to maintain communication by always decoding DCI format 1A regardless of the transmission mode.

The method of transmitting and receiving the downlink control channel and the downlink control information and the search space in the conventional LTE and LTE-A have been described.

Hereinafter, the downlink control channel in the 5G communication system which is currently discussed is described in more detail with reference to the drawings.

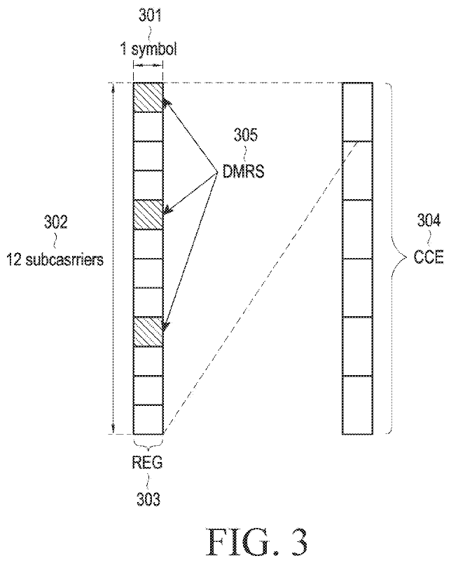

FIG. 3 illustrates an example of the basic unit of time and frequency resources included in a downlink control channel in the 5G system.

Referring to FIG. 3, a resource element group (REG) 303 which is the basic unit of time and frequency resources included in a control channel includes 1 OFDM symbol 301 in the time axis and 12 subcarriers 302, that is, 1 resource block (RB) in the frequency axis. In the configuration of the basic unit of the control channel, a data channel and a control channel can be time-multiplexed within one subframe on the basis of assumption that the basic unit of the time axis is 1 OFDM symbol 301. It is easy to satisfy the delay time requirements through a decrease in processing time of the user by placing the control channel ahead of the data channel. It is possible to more efficiently perform frequency multiplexing between the control channel and the data channel by configuring the basic unit on the frequency axis of the control channel as 1 RB 302.

By concatenating REGs 303 illustrated in FIG. 3, various sizes of control channel regions may be configured. When the basic unit of allocation of the downlink control channel in the 5G system is a control channel element (CCE) 304, one CCE 304 may include a plurality of REGs 303. In an example of the REG 303 illustrated in FIG. 3, the REG 303 may include 12 REs, and it means that 1 CCE 304 may include 72 REs if 1 CCE 304 includes 6 REGs 303. When a downlink control region is configured, the corresponding region may include a plurality of CCEs 304, and a particular downlink control channel may be mapped to one or a plurality of CCEs 304 according to an aggregation level (AL) within the control region and then transmitted. The CCEs 304 within the control region may be identified by numbers, and the numbers may be assigned according to a logical mapping scheme.

The basic unit of the downlink control channel illustrated in FIG. 3, that is, the REG 303, may include all of REs to which the DCI is mapped and REs to which a demodulation reference signal (DMRS) 305, which is a reference signal for decoding the REs, is mapped. As illustrated in FIG. 3, the DMRS 305 may be transmitted in 3 REs within 1 REG 303. For reference, the DINARS 305 is transmitted using precoding such as a control signal mapped within the REG 303, and thus the UE may decode control information without any information on which precoding is applied by the BS.

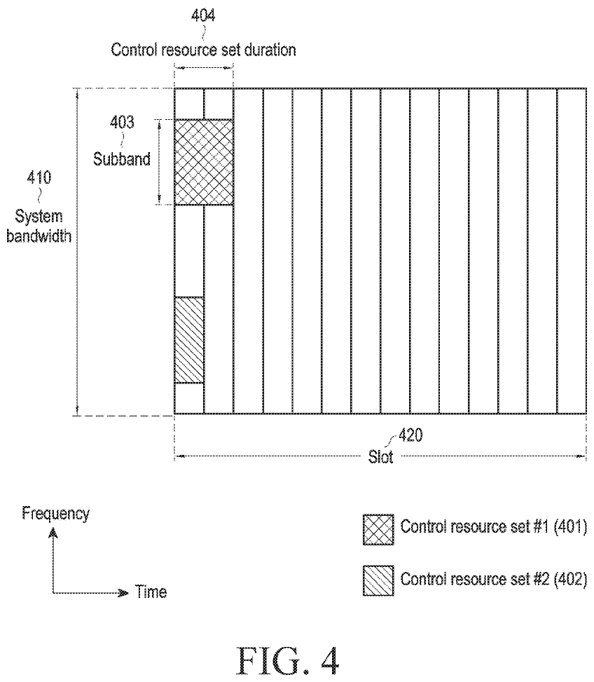

FIG. 4 illustrates an example of a control region (control resource set (CORESET) in which a downlink control channel is transmitted in the 5G system.

The example of FIG. 4 corresponds to the case in which 1 slot is assumed as 7 OFDM symbols. FIG. 4 illustrates an example in which a system bandwidth 410 is configured in the frequency axis and two CORESETs (CORESET #1 401 and CORESET #2 402) are configured within 1 slot 420 in the time axis. Frequencies of the CORESETs 401 and 402 may be configured as specific subbands 403 within the entire system bandwidth 410. Time duration of the CORESETs 401 and 402 may be configured as one or a plurality of OFDM symbols, and may be defined as control resource set duration 404. In one example of FIG. 4, CORESET #1 401 may be configured as CORESET duration of two symbols, and CORESET #2 402 may be configured as CORESET duration of one symbol.

The CORESET in the 5G system may be configured in the UE by the BS through higher-layer signaling (for example, system information, a master information block (MIB), or radio resource control (RRC) signaling). Configuring the CORESET in the UE means providing information such as the CORESET location, a subband, resource allocation of the CORESET, and CORESET duration. For example, configuration information may include information shown in [Table 2].

TABLE 2
- configuration information 1. Frequency axis RB allocation information
- configuration information 2. CORESET start symbol
- configuration information 3. CORESET symbol duration
- configuration information 4. REG bundling size (2, 3, or 6)
- configuration information 5. Transmission ode (Interleaved transmission
scheme or - non-interleaved transmission scheme)
- configuration information 6. DMRS configuration information (precoder
granularity)
- configuration information 7. Search space type (common search space,
group-common search space, or UE-specific search space)
- configuration information 8. DCI format to be monitored in
corresponding CORESET others

The configuration information in [Table 2] is an example of the disclosure, and various pieces of information required for transmitting a downlink control channel as well as the configuration information in [Table 2] may be configured in the UE.

Subsequently, downlink control information (DCI) in the 5G system will be described in detail.

Scheduling information for uplink data (physical uplink shared channel (PUSCH)) or downlink data (physical downlink shared channel (PDSCH)) in the 5G system is transferred from the BS to the UE through DCI.

The UE may monitor a fallback DCI format and a non-fallback DCI format for the PUSCH or the PDSCH. The fallback DCI format may be configured as a fixed field between the BS and the UE, and the non-fallback DCI format may include a configurable field.

According to an embodiment of the disclosure, the fallback DCI scheduling the PUSCH may include information in [Table 3].

TABLE 3

- Identifier for DCI formats - [1] bit
- Frequency domain resource assignment −[
┌log₂(N_{RB} [symbol] BWP(N_{RB} [symbol] BWP +1)/2)┐ ] bits
- Time domain resource assignment - X bits
- Frequency hopping flag - 1 bit.
- Modulation and coding scheme - [5] bits
- New data indicator - 1 bit
- Redundancy version - [2] bits
- HARQ process number - [4] bits
- TPC command for scheduled PUSCH - [2] bits
- UL/SUL indicator - 0 or 1 bit [symbol]
indicates data missing or illegible when filed

According to an embodiment of the disclosure, the non-fallback DCI scheduling the PUSCH may include information in [Table 4].

```
TABLE 4
  Carrier indicator - 0 or 3 bits
  Identifier for DCI formats - [1] bits
  Bandwidth part indicator - 0, 1 or 2 bits
  Frequency domain resource assignment
    For resource allocation type 0, ┌N_{RB}^{UL,BWP}/P┐ bits
    For resource allocation type 1, ┌log₂(N_{RB}^{UL,BWP}(N_{RB}^{UL,BWP} + 1)/2)┐
    bits
  Time domain resource assignment -1, 2, 3, or 4 bits
  VRB-to-PRB mapping - 0 or 1 bit, only for resource allocation
type 1.
    0 bit if only resource allocation type 0 is configured;
    1 bit otherwise.
  Frequency hopping flag - 0 or 1 bit, only for resource
allocation type 1.
    0 bit if only resource allocation type 0 is configured;
    1 bit otherwise.
  Modulation and coding scheme - 5 bits
  New data indicator - 1 bit
  Redundancy version - 2 bits as defined in section x.x of 16,
  TS38.214]
  HARQ process number - 4 bits
  1st downlink assignment index - 1 or 2 bits
    1 bit for semi-static HARQ-ACK codebook:
    2 bits for dynamic HARQ-ACK codebook with single
    HARQ-ACK codebook.
  2nd downlink assignment index - 0 or 2 bits
    2 bits for dynamic HARQ-ACK codebook with two HARQ-ACK
    sub-codebooks;
    0 bit otherwise.
  TPC command for scheduled PUSCH - 2 bits
  $SRS resource indicator ⌈ {log}_{2} ( {\sum }_{k = 1}^{{L}_{obj}} ( \begin{matrix}{N}_{SRS} \\ k\end{matrix} ) ) ⌉ or ⌈ {log}_{2} ( {N}_{SRS} ) ⌉ bits$
  $⌈ {log}_{2} ( {\sum }_{k = 1}^{{L}_{obj}} ( \begin{matrix}{N}_{SRS} \\ k\end{matrix} ) ) ⌉ bits for non - codebook based PUSCH$
  transmission;
  ┌log₂(N_{SRS})┐ bits for codebook based PUSCH transmission.
  Precoding information and number of layers -up to 6 bits
  Antenna ports - up to 5 bits
  SRS request · 2 bits
  CSI request - 0. 1, 2, 3, 4, 5. or 6 bits
  CBG transmission information - 0, 2, 4, 6, or 8 bits
  PTRS-DMES association - 2 bits.
  beta_offset indicator - 2 bits
  DMRS sequence initialization - 0 or 1 bit
  UL/SUL indicator - 0 or 1 bit
```

According to an embodiment of the disclosure, the fallback DCI scheduling PDSCH may include information in [Table 5].

TABLE 5

- Identifier for DCI formats - [1] bit
- Frequency domain resource assignment
−[┌log₂(N_{RB}^{DL,BWP}(N_{RB}^{DL,BWP} + 1)/2)┐ ] bits
- Time domain resource assignment - X bits
- VRB-to-PRB mapping - 1 bit.
- Modulation and coding scheme - [5] bits
- New data indicator - 1 bit
- Redundancy version - [2] bits
- HARQ process number - [4] bits
- Downlink assignment index - 2 bits
- TPC command for scheduled PUCCH - [2] bits
- PUCCH resource indicator - [2] bits
- PDSCH-to-HARQ feedback timing indicator - [3] bits

According to an embodiment of the disclosure, the non-fallback DCI scheduling the PDSCH may include information in [Table 6].

TABLE 6

| - | Carrier indicator - 0 or 3 bits |
|---|---|
| - | Identifier for DCI formats - [1] bits |
| - | Bandwidth part indicator - 0, 1 or 2 bits |
| - | Frequency domain resource assignment |
| • | For resource allocation type 0, ┌N_{RB}^{DL,BWP} / P┐ bits |
| • | For resource allocation type 1, |
| | ┌log₂(N_{RB}^{DL,BWP}(N_{RB}^{DL,BWP} + 1)/2)┐ bits |
| - | Time domain resource assignment -1, 2, 3, or 4 bits |
| - | VRB-to-PRB mapping - 0 or 1 bit, only for resource |
| allocation type 1. | |
| • | 0 bit if only resource allocation type 0 is configured: |
| • | 1 bit otherwise, |
| - | PRB bundling size indicator - 1 bit |
| - | Rate matching indicator - 0, 1, 2 bits |
| - | ZP CSI-RS trigger - X bits |
| For transport block 1: | |
| - | Modulation and coding scheme - 5 bits |
| - | New data indicator - 1 bit |
| - | Redundancy version - 2 bits |
| For transport block 2: | |
| - | Modulation and coding scheme - 5 bits |
| - | New data indicator - 1 bit |
| - | Redundancy version - 2 bits |
| - | HARQ process number - 4 bits |
| - | Downlink assignment index - 0 or 4 bits |
| - | TPC command for scheduled PUCCH - 2 bits |
| - | PUCCH resource indicator |
| - | PDSCH-to-HARQ_feedback timing indicator - 3 bits |
| - | Antenna ports - up to 5 bits |
| - | Transmission configuration indication - 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 0 or 1 bit |

The DCI may be transmitted through a physical downlink control channel (PDCCH) corresponding to a downlink physical control channel via a channel coding and modulation process. A cyclic redundancy check (CRC) is added to a DCI message payload and is scrambled by a radio network temporary identifier (RNTI) corresponding to the identity of the UE.

Depending on the purpose of the DCI message, for example, UE-specific data transmission, a power control command, or a random access response, different RNTIs are used. The RNTI is not explicitly transmitted, but is transmitted in the state of being included in a CRC calculation process. When the UE receives the DCI message transmitted on the PDCCH, the UE may identify the CRC by using the allocated RNTI. When the CRC identification result is correct, the UE may know that the corresponding message is transmitted to the UE.

For example, DCI scheduling the PDSCH for system information (SI) may be scrambled by an SI-RNTI. DCI scheduling a PDSCH for a random access response (RAR) message may be scrambled by an RA-RNTI. DCI scheduling a PDSCH for a paging message may be scrambled by a P-RNTI. DCI notifying of a slot format indicator (SFI) may be scrambled by an SH-RNTI. DCI notifying of transmit power control (TPC) may be scrambled by a TPC-RNTI. DCI scheduling a UE-specific PDSCH or PUSCH may be scrambled by a cell RNTI (C-RNTI).

When a specific UE receives scheduling of a data channel, that is, the PDSCH or the PDSCH through the PDCCH, data may be transmitted and received along with the DMRS within the corresponding scheduled resource region.

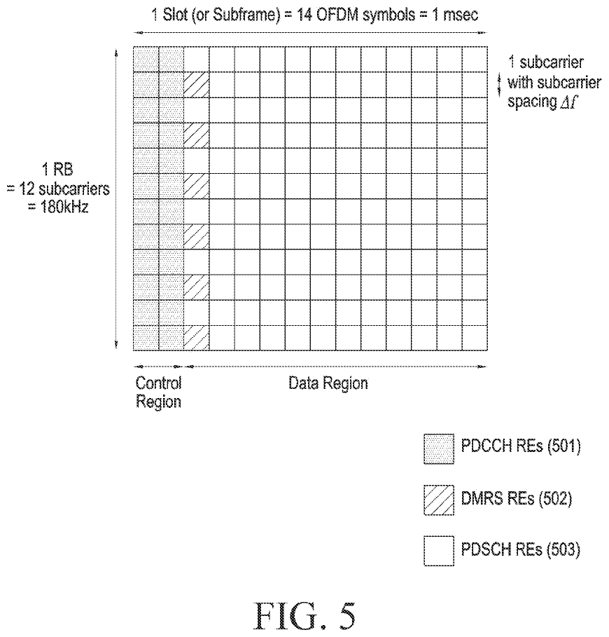

FIG. 5 illustrates an example of a configuration for the downlink RB structure in the 5G system.

More specifically, FIG. 5 illustrates the case in which a specific UE uses 14 OFDM symbols as 1 slot (or subframe) in the downlink, and a PDCCH is transmitted through the first two OFDM symbols and a DMRS is transmitted in a third symbol. In FIG. 5, PDSCHs are mapped to REs in which no DMRS is transmitted in a third symbol and to REs in fourth to last symbols and transmitted within a specific RB in which PDSCHs are scheduled. Subcarrier spacing Δf in FIG. 5 is 15 kHz in the LTE/LTE-A systems and uses one of {15, 30, 60, 120, 240, 480} kHz in the 5G system.

Meanwhile, as described above, the BS should transmit a reference signal to measure a downlink channel state in a cellular system. In the case of the long-term evolution advanced (LTE-A) system of 3GPP, the UE may measure a channel state between the BS and the UE on the basis of a CRS or a CSI-RS transmitted by the BS.

The channel state should be measured in consideration of various factors including an amount of interference in the downlink. The amount of interference in the downlink may include an interference signal generated by an antenna that belongs to a neighboring BS, a thermal noise, and the like, which is important when a UE determines the channel state of the downlink. For example, when one BS having one transmission antenna transmits a signal to one UE having one reception antenna, the UE is required to decide Es/Io by determining energy per symbol which can be received in the downlink through the reference signal received from the BS and an amount of interference simultaneously received in a section where the corresponding symbol is received. The determined Es/Io is converted into a data transmission rate or a value corresponding thereto and transmitted to the BS in the form of a channel quality indicator (CQI). Then, the BS may determine a data transmission rate at which the BS performs transmission to the UE in the downlink.

More specifically, in the LTE-A system, the UE transmits feedback of information on the channel state of the downlink to the BS and allows the BS to use the same for downlink scheduling. That is, the UE measures a reference signal transmitted by the BS in the downlink and transmits feedback of information extracted from the measured reference signal to the BS in the form defined by the LTE/LTE-A standard. As described above, the information fed back by the UE in LTE/LTE-A may be referred to as channel state information, and the channel state information may include three pieces of information below.
Rank indicator (RI): indicates the number of spatial layers which the terminal can receive in the current channel state
Precoding matrix indicator (PMI): indicates an indicator of a precoding matrix which the UE prefers in a current channel state
Channel quality indicator (CQI): indicates a maximum data rate at which the UE can perform reception in a current channel state

The CQI may be replaced with a signal to interference plus noise ratio (SINR), a maximum error correction code rate and modulation scheme, data efficiency per frequency, and the like, which can be used similarly to the maximum data transmission rate.

The RI, PMI, and CQI have meanings associated with each other. For example, the precoding matrix supported by LTE/LTE-A is differently defined according to each rank. Accordingly, X which is a PMI value when the RI has a value of 1 and X which is a PMI value when the RI has a value of 2 may be differently interpreted.

Further, for example, even when the UE determines the CQI, it is assumed that X which is the PMI value of which the UE notifies the BS is applied to the BS. That is, reporting RI_X, PMI_Y, and CQI_Z to the BS by the UE corresponds to reporting that the corresponding UE can perform reception at a data transmission rate corresponding to CQI_Z when the rank is RI_X and the PMI is PMI_Y. As described above, in calculating the CQI, the UE considers which transmission scheme is used for the BS and optimal performance can be acquired when actual transmission is performed using the corresponding transmission scheme.

In LTE/LTE-A, the RI, the PMI, and the CQI that are channel state information fed back by the UE may be fed back periodically or aperiodically. When the BS desires to aperiodically acquire channel state information of a specific UE, the BS may configure aperiodic feedback (or an aperiodic channel state information report) using an aperiodic feedback indicator (or a channel state information request field or channel stale information request information) included in downlink control information (DCI) for the UE. Further, when receiving an indicator configured to transmit aperiodic feedback in an n^{th} subframe, the UE may perform uplink transmission including aperiodic feedback information (or channel state information) in data transmission in an n+k^{th} subframe. Here, k denotes a parameter defined in the 3GPP LTE Release 11 standard, which is 4 in frequency division duplexing (FDD), and may be defined as shown in [Table 7] in time division duplexing (TDD).

TABLE 7

| TDD UL/DL | subframe number n | | | | | | | | | |
|---|---|---|---|---|---|---|---|---|---|---|
| Configuration | 0 | 1 | 2 | 3 | 4 | 5 | 6 | 7 | 8 | 9 |
| 0 | — | — | 6 | 7 | 4 | — | — | 6 | 7 | 4 |
| 1 | — | — | 6 | 4 | — | — | — | 6 | 4 | — |
| 2 | — | — | 4 | — | — | — | — | 4 | — | — |
| 3 | — | — | 4 | 4 | 4 | — | — | — | — | — |
| 4 | — | — | 4 | 4 | — | — | — | — | — | — |
| 5 | — | — | 4 | — | — | — | — | — | — | — |
| 6 | — | — | 7 | 7 | 5 | — | — | 7 | 7 | — |

[Table 7] shows values of k for subframe numbers n in TDD UL/DL configuration.

When aperiodic feedback is configured, the feedback information (or channel state information) may include the RI, the PMI, and the CQI, and the RI and the PMI may not be fed hack according to the feedback configuration (or channel state report configuration).

In the disclosure, an in-band full-duplex (hereinafter, referred to as full-duplex) system is a system in which an uplink signal and a downlink signal can be simultaneously transmitted within the same band and the same time resources unlike a time division duplexing (TDD) system or a frequency division duplexing (FDD) system. That is, in the full-duplex system, uplink and downlink signals may exist within the same cell during the same time interval, which acts as interference. At this time, an operation of the in-band full-duplex system may include only one of the uplink or the downlink, or may include both the uplink and the downlink. Further, in transmission of in-band full-duplex, interference may include not only a signal transmitted in the band but also leakage generated by the signal. The full-duplex operation may be performed only for some bands of the usage bands or performed over the entire bands. In the disclosure, simultaneous transmission in the full-duplex system is mainly described to appear on a transmitter and a receiver belonging to one node, but may be analyzed to include a full-duplex operation between different nodes when information required for the full-duplex operation can be shared through mutual information sharing even though the transmitter and the receiver belong to different nodes.

Interference additionally generated due to the use of the full-duplex system is classified into two such as self-interference and cross-link interference.

Self-interference is interference that is generated by a transmitting side of a node (A) and received by a receiving side of the node (A) when one node (A) receives a signal of another node (B). At this time, the node may correspond to various communication entities such as a BS, a UE, and an IAB. Further, even though entities recognized as one node are physically separated from each other, the entities may be recognized as one node if they are wiredly connected to share information or wirelessly connected to share information. Accordingly, self-interference may be analyzed as interference generated between different two nodes which can share information therebetween. Self-interference may include not only signals received in the same hand but also signals received in different bands. Self-interference may include out-of-band radiation generated due to signal transmission in different bands. Self-interference is transmitted and received within a distance shorter than a desired signal, thereby significantly reducing a signal to interference and noise ratio (SINR) of the desired signal. Accordingly, the transmission performance of the full-duplex system is greatly influenced by the performance of a self-interference cancellation technology.

Cross-link interference is interference received, when a BS performs uplink reception from a UE, from downlink transmission of another BS in the same band and interference received, when a UE performs downlink reception, from uplink transmission of another UE. In the case of cross-link interference which a BS receiving an uplink signal receives from downlink transmission of another BS, the distance between the BS and the other BS is longer than the distance between the BS and a UE transmitting a demand signal of the BS but interference transmission power is generally greater than transmission power of the UE by 10 to 20 dB or more, and thus the received SINR performance of the uplink desired signal of the UE received by the BS may be significantly influenced. Further, the UE performing downlink reception may receive cross-link interference from another UE using the uplink in the same band. At this time, when the distance between the other UE giving interference and the UE performing downlink reception is meaningfully closer to the distance between the BS and the UE performing the downlink reception, the downlink desired signal received SNIR performance of the UE may be reduced. The meaningfully close distance means a close state enough to reduce the performance of a downlink reception SINR of the UE since the downlink reception UE has greater reception power of interference from an uplink signal of another UE than power of a signal received from the BS.

In a cellular-based mobile communication system, types of a full-duplex system are divided into a type in which a self-interference cancellation (SIC) function for supporting the full-duplex operation is supported by only the BS and a type in which the same is supported by both the BS and the UE. The reason why the case in which only the UE has the SIC function is not considered is that the BS more easily implements antenna separation self-interference cancellation, RF-circuit self-interference cancellation, and digital self-interference cancellation functions which are elements than the UE in aspects of the form factor size, the circuit structure, and the like.

For the type of the full-duplex system considered in the disclosure, the case in which only the BS basically has a self-interference cancellation function, but the disclosure may be equally applied to and operate in the case in which both the UE and the BS have the self-interference cancellation function. Accordingly, hereinafter, the term UE or BS refers to not only one BS or UE but also a device having a transmission/reception function and also different transmission and reception devices which perform transmission and reception with each other.

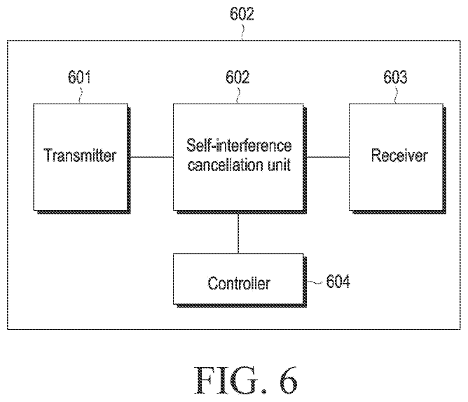

FIG. 6 illustrates a configuration of a transmission/reception device having a self-interference cancellation function in the full-duplex system according to an embodiment of the disclosure.

The structure of a transmission/reception device 600 can be equally applied to the BS and the UE, and does not specify the structure of any one of the BS and the UE. However, the disclosure assumes that the BS basically has the self-interference cancellation function and configures the full-duplex system, and thus it is assumed and described that the transmission/reception device 600 is the BS for convenience.

In FIG. 6, the BS 600 may include a transmitter 601 for transmitting a downlink signal to the UE, a self-interference cancellation unit 602 for cancelling self-interference, a receiver 603 for receiving an uplink signal from the UE, and a controller 604 controlling the transmitter 601, the self-interference cancellation unit 601, and the receiver 603. A detailed configuration method of each element of the BS 600 may vary depending on an implementation method of the BS.

As described above, the transmission/reception device 600 may correspond to the UE, in which case the UE also may include a transmitter 601 for transmitting an uplink signal to the BS, a self-interference cancellation unit 602 for cancelling self-interference, a receiver 603 for receiving a downlink signal from the BS, and a controller 604 controlling the transmitter 601, the self-interference cancellation unit 601, and the receiver 603.

Meanwhile, although FIG. 6 illustrates that the transmitter 601, the self-interference cancellation unit 601, and the receiver 603 operate while being separated, it should be noted that some or all of the functions/or elements of the self-interference cancellation unit 601 can operate while being included in the transmitter 601 and/or the receiver 603.

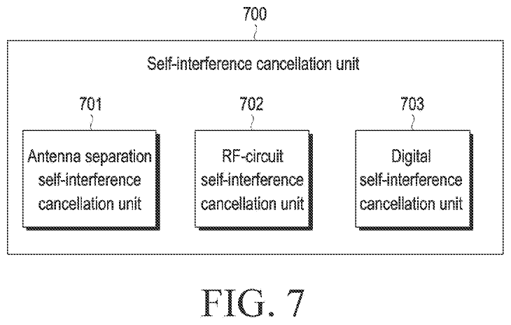

FIG. 7 illustrates a configuration of the self-interference cancellation unit according to an embodiment of the disclosure.

As described above, the self-interference cancellation unit 700 may perform self-interference cancellation. The self-interference cancellation unit 700 in FIG. 7 may include at least one of an antenna separation self-interference cancellation unit 701, an RF-circuit self interference cancellation unit 702, and a digital self interference cancellation unit 703, but the configuration of the self-interference cancellation unit 700 is not limited to the above example. Further, the RF circuit self-interference cancellation unit may not be included as necessary, and the antenna separation self-interference cancellation unit may not also be included as necessary. At least one of the self-interference cancellation units 701, 702, and 703 may be activated to perform transmission and reception as necessary.

The antenna separation self-interference cancellation unit 701 may include antennas of a transmitting side (or a transmitter) and a receiving side (or a receiver) which are physically separated and allow the receiving side antenna to sufficiently attenuate self-interference. At this time, physical separation between the antenna of the transmitting side and the antenna of the receiving side may mean the use of a separation method using attenuation interference of the antenna in order to make a downlink transmission signal received by an uplink receiving side antenna with low power, a method using a circulator in the same antenna, a method using a cross-pole structure, a method using an isolator, and the like. However, the physical separation is not limited to the above example, and may mean separation methods by which a downlink transmission signal can be received by an uplink receiving side of the BS with low power.

The RF-circuit self-interference cancellation unit 702 may include an analog to digital converter and serve to attenuate the strength of a self-interference signal before the self-interference signal is quantized. An RF circuit included in the RF-circuit self-interference cancellation unit 702 may imitate a channel which a self-interference signal transmitted from a transmitting side of the BS experiences to arrive at the RF-circuit self-interference cancellation unit 702 via a radio channel and the antenna separation self-interference cancellation unit 702.

For example, a reception signal y(t) passing through the antenna separation self-interference cancellation unit 701 and the radio channel for an analog domain transmission signal x(t) of the BS may be expressed as shown in [Equation 1] below.

y(t)=x(t)*h(t)+n(t) [Equation 1]

In the above equation, h(t) indicates a time domain impulse response of the radio channel and the antenna separation self-interference cancellation unit 701, and n(t) indicates white noise. Further, * indicates a convolution operation. At this time, the RF-circuit of the RF-circuit self-interference cancellation unit 702 may be configured to generate a similar channel h′(t) which imitates h(t) by using a time delay module, a phase shift module, an amp module, or the like. The self-interference signal is imitated by passing the transmission signal x(t) Which can be directly obtained from the transmitting side of the BS through the RF-circuit. The imitated self-interference signal x(t)*h′(t) is attenuated from the self-interference signal y(t) as shown in [Equation 2] below.

y\hat{ }′(t)=x(t)*h(t)−x(t)*h′(t)+n(t) [Equation 2]

A bandwidth in which the performance of the RF-circuit self-interference cancellation unit 702 is maintained may vary depending on bandwidths of elements of the RF-circuit, for example, the time delay module, the phase shift module, the amp module, or the like. For example, when the bandwidth in which the performance of the RF-circuit self-interference cancellation unit 702 is maintained is less than the system bandwidth, restriction of the bandwidth of the self-interference cancellation unit is not due to limitation on the analog circuit.

Last, the digital self-interference cancellation unit 702 may cancel a self-interference signal X[n] from Y[n] obtained by switching the signal y′(t) after passing through an RF-self-interference unit to the frequency domain after passing through the ADC. For example, as shown in [Equation 3] below, a digital domain channel H[n] which the transmission signal X[n] experiences is estimated and a signal obtained by multiplying the estimated channel H′[n] and X[n] is subtracted from the reception signal Y[n]. At this time, the performance of the digital self-interference cancellation unit is determined by a similarity between the estimated channel H′[n] and the real channel H[n]. That is, as the similarity between H′[n] and H[n] is higher, the performance of the digital self-interference cancellation unit becomes higher.

Y\hat{ }′[n]=X[n]H[n]−X[n]H′[n]+n(t) [Equation 3]

Hereinafter, embodiments of the disclosure will be described in detail with reference to the accompanying drawings. Hereinafter, embodiments of the disclosure are described by way of example of the LTE or LTE-A system, but the embodiments of the disclosure may be applied to other communication systems having the similar technical background or channel form. For example, the communication system to which embodiments of the disclosure are applied may include a 5th-generation mobile communication technology (5G, new radio, or NR) developed after LTE-A. Accordingly, embodiments of the disclosure can be applied to other communication systems through some modifications without departing from the scope of the disclosure on the basis of a determination of those skilled in the art.

In the following description of the disclosure, a detailed description of known functions or configurations incorporated herein will be omitted when it may make the subject matter of the disclosure rather unclear. The terms as described below are defined in consideration of the functions in the embodiments, and the meaning of the terms may vary according to the intention of a user or operator, convention, or the like. Therefore, the definitions of the terms should be made based on the contents throughout the specification.

The disclosure considers a method of additionally cancelling interference of the self-interference signal y′(t) from which interference is cancelled without any assistance of the RF-circuit self-interference cancellation unit or with assistance of the RF-circuit self-interference cancellation unit through a digital self-interference cancellation function.

A non-linear signal distorted from the self-interference signal passing through elements of the transmitting side such as a digital to analog converter (DAC), a mixer, or a power amplifier (PA) should be considered for a digital self-interference cancellation function during self-interference cancellation of the full-duplex operation. This is expressed as shown in [Equation 4] below.

x(t)+x_{NL}(t) [Equation 4]

In the above equation, x(t) transmitted by the transmitting side corresponds to a self-interference transmission signal in the time axis domain, and x_{NL}(t) is a non-linear signal generated due to the elements of the transmitting side.

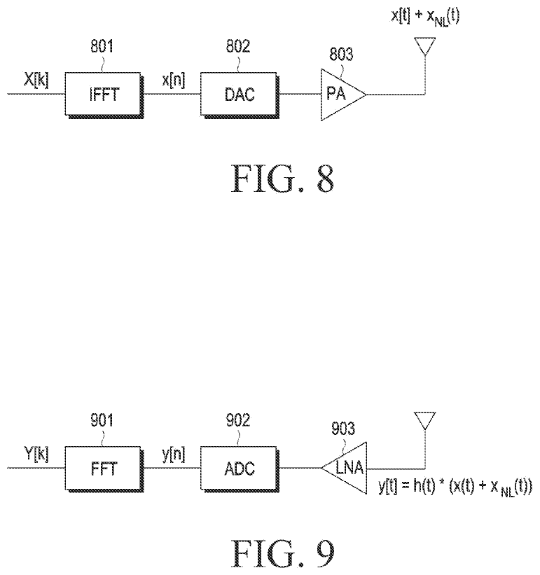

FIG. 8 illustrates the flow of a transmission signal generated on the transmitting side.

In FIG. 8, X[k] is a frequency axis signal, and is changed to a time axis signal x[n] through inverse Fourier transform (IFFT) and converted into an analog signal x(t) via the DAC. The analog signal x(t) includes a non-linear signal x_{NL}(t) by passing through the elements of the transmitting side, and the signal corresponding to [Equation 4] is finally transmitted through the antenna. [Equation 4] shows a signal from which the size of the transmission signal amplified via the elements of the transmitting side, the delay of the signal, an error, and the like are omitted and is simplified for description, and the disclosure should be understood in sufficient consideration of the above-described additional factor.

In FIG. 8, an IFFT 801, a DAC 802, and a PA 803 included in the transmitting side briefly show main elements include in the general communication system, but do not represent all elements corresponding to the transmitting side. The disclosure can be applied to all systems in which general self-interference is performed, and thus can be applied to all communication systems in which a non-linear signal is generated via elements of the transmitting side without limiting to some examples illustrated in FIG. 8. Further, x_{NL}(t) indicates any signal other than the transmission signal x(t) which the transmitting side desires to transmit to another receiving side and does not indicate only the non-linear signal. The transmission operation illustrated in FIG. 8 is the structure normally included in a general OFDM system and SC FDMA system, and accordingly the disclosure can be overall applied to the corresponding systems,

In the full-duplex operation, the signal received by the receiving side is shown as [Equation 5] below via a radio channel. A transmission signal x(t)+x_{NL}(t) including a non-linear signal is received via a plurality of reception paths, which is indicated in the form of the convolution operation (indicated by * in [Equation 5] below) with a channel H.

y(t)=H*(x(t)+x_{NL}(t)) [Equation 5]

All signals received by the receiving side except for the self-interference signal such as a reception signal from another node except for the self-interference signal received through a channel, interference from another node, and noise due to an environment are omitted for convenience of description in [Equation 5], but it should be understood that the operation is performed including the signals. Further, it should be considered that some of the reception signals may be or may not be received according to circumstances.

FIG. 9 illustrates the flow of the reception signal generated on the receiving side.

In FIG. 9, a FFT 901, a DAC 902, and a PA 903 included in the receiving side briefly show main elements include in the general communication system, but do not represent all elements corresponding to the receiving side. The disclosure can be applied to all systems in which general self-interference is performed, and thus can be applied to all communication systems without limiting to some examples illustrated in FIG. 9.

Referring to FIG. 9, a reception signal y(t) is converted into a time axis digital signal y[n] through an ADC 902 via an LNA 903 and converted into a frequency axis digital signal Y[n] through a fast Fourier transform (FFT) 901. The reception operation according to an embodiment of FIG. 9 is the structure normally included in the general OFDM system and SC FDMA system, and accordingly the disclosure can be overall applied to the corresponding systems.

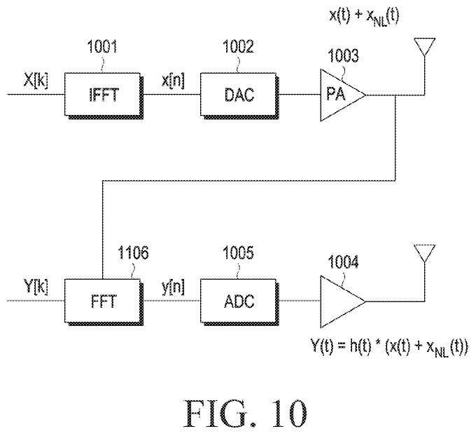

FIG. 10 illustrates the structure of a transceiver for performing the conventional digital self-interference cancellation.

Referring to FIG. 10, a frequency axis digital signal X[k] of the transmitting side is converted into a time axis digital signal x[n] while passing through an IFFT 1001. Further, the time axis digital signal x[n] of the transmitting side is converted into a time axis analog signal x(t) while passing through a DAC 1002. In addition, the time axis analog signal x(t) is converted into a signal x(t)+x_{NL}(t) including a non-linear (NL) signal while passing through a PA 1003, transmitted through an antenna of the transmitting side, and then received as a reception signal y(t) by an antenna of the receiving side through a radio channel. y(t) is converted into a time axis digital signal y[n] while passing through an LNA 1004 and an ADC 1005 of the receiving side. Further, the time axis digital signal y[n] is converted into a frequency axis digital signal Y[n] while passing through an FFT 1006 of the receiving side.

In the conventional digital self-interference cancellation method, in order to cancel self-interference due to a non-linear signal of the transmitting side, the transmitting side transfers a signal x(t)+x_{NL}(t) including the non-linear signal generated while passing through the PA 1003 to the FFT 1006 of the receiving side and removes a frequency axis digital signal X[n]+X_{NL}[n] obtained by performing FFT for the signal x(t)++x_{NL}(t) from the frequency axis digital signal Y[n].

The digital self-interference cancellation method illustrated in FIG. 10 can directly remove the self-interference signal including the non-linear signal from the reception signal and thus has higher accuracy of self-interference cancellation and a higher performance gain but has the following problem.

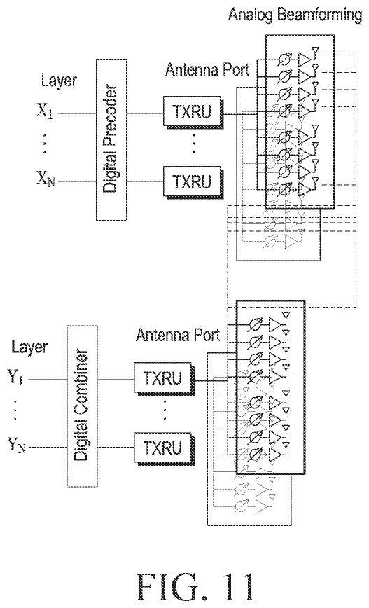

FIG. 11 illustrates multi-panel structures of the transmitting side and the receiving side.

Referring to FIG. 11, when the transmitting side and the receiving side have multiple panels including phase shifters and PAs, the number of PAs increases, the number of signals of the transmitting side including non-linear signals which the transmitting side transmits to the receiving side increases, and thus complexity of cancelling digital self-interference increases in the conventional digital self-interference cancellation method. That is, when multiple panels are used, the conventional digital self-interference cancellation method needs an additional design to remove and operate radio frequency (RF) lines after the PA.

Accordingly, a new method of reducing complexity of digital self-interference cancellation and improving a self-interference cancellation gain is required.

Accordingly, the disclosure describes a digital self-interference cancellation method using parallel Hammerstein (PH) modeling.

[Equation 6] below shows a transmission signal and a non-linear signal of the transmission signal through PH modeling. PH modeling expresses a non-linear signal generated by elements of the transmitting side through a plurality of polynomials.

x(t)+x_{NL}(t)+a₁x(t)+a₃x⁽³⁾(t)+a₅x⁽⁵⁾(t)+ . . . [Equation 6]

In [Equation 6] above, a₃x⁽³⁾(t)+a₅x⁽⁵⁾(t)+ . . . corresponding to the non-linear signal corresponds to modeling of the above-described non-linear signal, and x_{NL}(t) is described by appropriately configuring non-linear signal coefficients such as a₁, a₃, and a₅. In [Equation 6] above, x_{NL}(t) indicates an nth-order signal sample derived from x(t) and means each term of the polynomial in [Equation 6]. Meanwhile, only odd-numbered terms which are main components are expressed in [Equation 6], but it should be understood that even-numbered terms are also included. Further, only three coefficients a₁, a₃, and a₅ of the non-linear signal coefficients are shown in [Equation 6], but it should be understood that normal n non-linear component coefficients such as non-linear signal coefficients a₁, a₃, a₅, . . . aₙ can be applied.

Hereinafter, embodiments of the disclosure for digital self-interference cancellation using PH modeling are described.

### Embodiment 1

Embodiment 1 describes a method of performing digital self interference cancellation in the time axis by using PH modeling in [Equation 6] in order to perform digital self-interference cancellation in the full-duplex operation.

[Equation 7] below shows a signal obtained by receiving a signal transmitted by the transmitting side via a channel, which is expressed by PH modeling.

y(t)=H*(x(t)+x_{NL}(t))=H*a₁x(t)+H*a₃x⁽³⁾(t)+H*a₅x⁽⁵⁾(t)+ . . . [Equation 7]

In the full-duplex operation, the operation for cancelling time axis self-interference is described below.

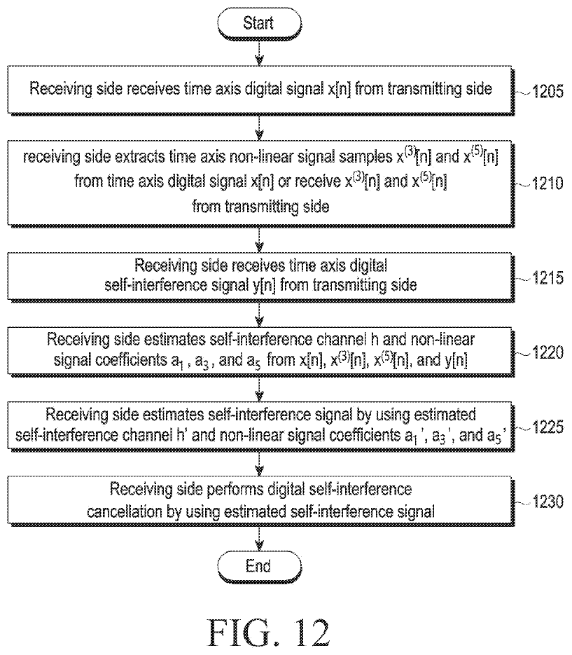

FIG. 12 illustrates a method of performing time axis self-interference cancellation in the full-duplex operation according to an embodiment of the disclosure. FIG. 12 provides a method of simultaneously estimating self-interference channels and non-linear signal coefficients from the received signal, estimating a self-interference signal by using the estimated self-interference channels and non-linear signal coefficients, and cancelling self-interference on a digital side.

Referring to FIG. 12, the receiving side receives a generated time axis digital signal x[n] from the transmitting side in operation 1205. The transmitting side or the receiving side extracts non-linear signal samples x⁽³⁾[n], x⁽⁵⁾[n], and the like for estimating PH modeling coefficients and channels for non-linear signals of the self-interference signals. For example, the transmitting side or the receiving side may extract non-linear signal samples x⁽³⁾[n], x⁽⁵⁾[n], and the like from the time axis digital signal x[n] through [Equation 8].

x^{(k)}[n]=x[n]x[n]|^{k-1} [Equation 8]

Meanwhile, only a third-order non-linear signal sample and a fifth-order non-linear signal sample of the non-linear signal are described in embodiment 1 for convenience of description, but it should be understood that embodiments of the disclosure can be widely applied to the case including a higher order and/or an even-numbered order. For example, although the disclosure describes the operation of embodiment 1 for two non-linear signal samples such as x⁽³⁾[n] and x⁽⁵⁾[n], the similar operation can be applied to general k non-linear signal samples such as non-linear signal samples x⁽³⁾[n], x⁽⁵⁾[n], . . . x^{(2k+1)}[n].

The receiving side may generate the non-linear signal samples x⁽³⁾[n] and x⁽⁵⁾[n] from information of the transmitting side or receive the same from the transmitting side in operation 1210. Further, the receiving side receives a time axis self-interference signal y[n] including a non-linear signal from the transmitting side through an interference channel in operation 1215. The relationship between the time axis self-interference signal y[n], the time axis digital signal x[n], and the non-linear signal samples x⁽³⁾[n] and x⁽⁵⁾[n] through PH modeling may be indicated by [Equation 9] below.

$$[ \begin{matrix}y [ 1 ] \\ y [ 2 ] \\ … \\ y [ N - 1 ] \\ y [ N ]\end{matrix} ] = {\sum }_{l = 0}^{L - 1} h ( l ) [ \begin{matrix}{a}_{1} x [ 1 - l ] \\ {a}_{1} x [ 2 - l ] \\ … \\ {a}_{1} x [ N - 1 - l ] \\ {a}_{1} x [ N - l ]\end{matrix} ] + {\sum }_{l = 0}^{L - 1} h ( l ) [ \begin{matrix}{a}_{3} {x}^{( 3 )} [ 1 - l ] \\ {a}_{3} {x}^{( 3 )} [ 2 - l ] \\ … \\ {a}_{3} {x}^{( 3 )} [ N - 1 - l ] \\ {a}_{3} {x}^{( 3 )} [ N - l ]\end{matrix} ] {+ \sum }_{l = 0}^{L - 1} h ( l ) [ \begin{matrix}{a}_{5} {x}^{( 5 )} [ 1 - l ] \\ {a}_{5} {x}^{( 5 )} [ 2 - l ] \\ … \\ {a}_{5} {x}^{( 5 )} [ N - 1 - l ] \\ {a}_{5} {x}^{( 5 )} [ N - l ]\end{matrix} ] \qquad [ Equation 9 ]$$

In [Equation 9] above, y indicates a time axis digital signal corresponding to a reception signal (self-interference signal), and x, x⁽³⁾, and x⁽⁵⁾ indicate a transmission signal and non-linear signal samples of the transmission signal in the time axis. N indicates the total number of samplings of the signal, and a₁, a₃, and a₅ indicate coefficients of the non-linear signal based on the result of PH modeling. h(1) indicates a channel coefficient of a delayed signal which is returned to a first tap after the time axis signal experiences multiple paths. At this time, 1 has an integer value from 0 to L-1, and L indicates a total number of taps of the multi-path channel.

The receiving side performs a process of estimating h(1) and a₁, a₃, and a₅ on the basis of [Equation 9]. That is, the receiving side may estimate the interference channel h(1) and the coefficients a₁, a₃, and a₅ of the non-linear signal by using the already known signals and signal samples y, x, x⁽³⁾, and x⁽⁵⁾ in operation 1020. For example, the estimation process of operation 1020 may apply the method used in the conventional channel estimation.

For example, when a Zerofocing channel estimator is used, the number N of samples of a reception signal y and a transmission signal and non-linear signal samples x, x(3), and x(5) corresponding thereto is configured to be greater than or equal to L×m which is the product of the number L of taps of the multi-path channel and the number in of considered non-linear signal coefficients. Further, a matrix is configured by the transmission signal and the non-linear signal samples x, x⁽³⁾, and x⁽⁵⁾, an inverse matrix or a pseudo inverse matrix of the configured matrix may be calculated, and h(1), a₁, a₃, and a₅ are simultaneously estimated by multiplying the inverse matrix or the pseudo inverse matrix and the reception signal y.

As described above, the process of estimating the non-linear signal of the self-interference channel passes through a process which is the same as the channel estimation process. However, there is difference from the conventional channel estimation scheme. While channel estimation considering only the linear signal is performed in the conventional channel estimation, a reference signal for channel estimation of the non-linear signal is generated in advance from a reference signal of the linear signal in order to estimate the non-linear signal in embodiments of the disclosure.

The receiving side acquires an estimation channel h′(1) of the interference channel h(1) and estimation values a′₁, a′₃, and a′₅ of the non-linear component coefficients a₁, a₃, and a₅ through the estimation process of operation 1220. The receiving side estimates the self-interference signal by using the acquired estimation channel h′(1) and a′₁, a′₃, and a′₅ in operation 1225. For example, the receiving side may estimate the self-interference signal through [Equation 10] below by using the transmission signal and the non-linear signal samples x, x⁽³⁾, and x⁽⁵⁾ and the estimation channel h′(1) and a′₁, a′₃, and a′₅ estimated in operation 1220.

h′*a′₁x[n]+h′*a′₃x⁽³⁾[n]+h′*a′₅x⁽⁵⁾[n] [Equation 10]

[Equation 10] above shows a signal obtained after the transmitted self-interference signal is received by the receiving side and then converted into a time axis digital signal while passing through the ADC, and the channel and non-linear signal coefficients acquired through the estimation process are used.

The receiving side removes the self-interference signal estimated in operation 1025 from the reception signal in order to receive a desired signal in operation 1230.

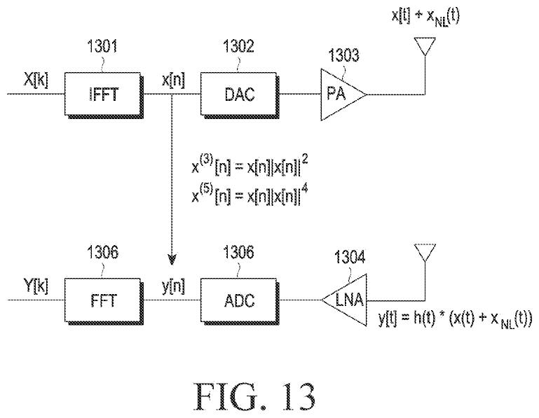

FIG. 13 illustrates the structure of a transceiver for performing time axis digital self-interference cancellation according to an embodiment of the disclosure.

Referring to FIG. 13, a frequency axis digital signal X[n] of the transmitting side is converted into a time axis digital signal x[n] while passing through an IFFT 1301. The time axis digital signal x[n] are transferred to the receiving side along with non-linear signal samples x⁽³⁾[n], x⁽⁵⁾[n] transformed while passing through a multiplier (not shown). Further, the time axis digital signal x[n] of the transmitting side is converted into a time axis analog signal x(t)+x_{NL}(t) including a non-linear signal while passing through a DAC 1302 and a PA 1303, transmitted through an antenna of the transmitting side, and then received as a reception signal y(t) by an antenna of the receiving side through a radio channel. y(t) is converted into a time axis digital signal y[n] while passing through an LNA 1304 and an ADC 1305. The receiving side estimates interference channels and non-linear signal coefficients by using x[n], x⁽³⁾[n], x⁽⁵⁾[n], and y[n] as described above and generates the interference signal by using the estimated interference channels and non-linear signal coefficients. Further, the receiving side cancels self-interference by using the generated interference signal.

### Embodiment 2

Embodiment 2 describes a method of performing digital self-interference cancellation in the frequency axis during the full-duplex operation.

[Equation 11] below shows modeling in which a signal x[n] transmitted by the transmitting side is received as a reception signal y[n] through a channel and then converted into a frequency signal via an ADC, FFT, and the like.

Y[n]=a₁HX[n]+a₃HX⁽³⁾[n]+a₅HX⁽⁵⁾[n]+ . . . [Equation 11]

In [Equation 11], frequency signal samples X^{(k)} are acquired by performing FFT on time axis signal samples x⁽ⁿ⁾ as shown in [Equation 12] below,

[symbol]

{x[1], x[2], . . . , x[N−1], x[N]}→X[1], X[2], . . . , X[N−1], X[N]

[symbol]

{x⁽³⁾[1], x⁽³⁾[2], . . . , x⁽³⁾[N−1], x⁽³⁾[N]}→X⁽³⁾[1], X⁽³⁾[2], . . . , X⁽³⁾[N−1], X⁽³⁾[N]

. . .

[symbol]

{x^{(k)}[1], x^{(k)}[2], . . . , x^{(k)}[N−1], x^{(k)}[N]}→X^{(k)}[1], X^{(k)}[2], . . . , X^{(k)}[N−1], X^{(k)}[N] [Equation 12]

An operation for cancelling frequency axis self-interference in the full-duplex operation is described below.

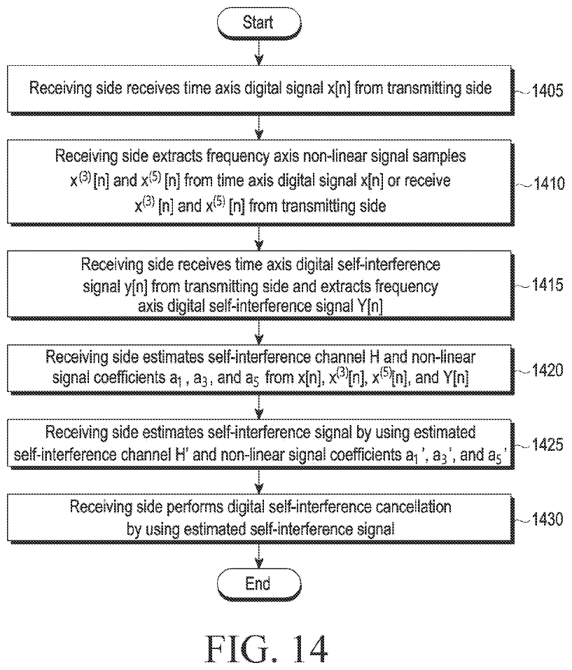

FIG. 14 illustrates a method of performing frequency axis self-interference cancellation in the full-duplex operation according to an embodiment of the disclosure. FIG. 14 provides a method of simultaneously estimating self-interference channels and non-linear component coefficients from the received signal, estimate a self-interference signal by using the estimated self-interference channels and non-linear component coefficients, and cancelling self-interference on a digital side.

Referring to FIG. 14, the receiving side receives a generated time axis digital signal x[n] from the transmitting side in operation 1405. The transmitting side or the receiving side extracts frequency axis digital signals X[n] and non-linear signal samples X⁽³⁾[n], X⁽⁵⁾[n], and the like for estimating non-linear signal coefficients of PH modeling and channels for the self-interference signal. For example, the transmitting side or the receiving side may extract time axis non-linear signal samples x⁽³⁾[n], x⁽⁵⁾[n], and the like from the time axis digital signal X[n] by using [Equation 8] and extract frequency axis non-linear signal samples X⁽³⁾[n], X⁽⁵⁾[n], and the like from the extracted non-linear signal samples x⁽³⁾[n], x⁽⁵⁾[n], and the like through [Equation 12]. Meanwhile, only a third-order non-linear signal sample and a fifth-order non-linear signal sample of the non-linear signal are described in embodiment 2 for convenience of description, but it should be understood that embodiments of the disclosure can be widely applied to the case including a higher order and/or an even-numbered order. For example, although the disclosure describes the operation of embodiment 2 for two non-linear signal samples such as X⁽³⁾[n] and X⁽⁵⁾[n], the similar operation can be applied to general k non-linear signal samples such as non-linear signal samples X⁽³⁾[n], X⁽⁵⁾[n], . . . X^{(2k+1)}[n].

The receiving side may generate the frequency axis non-linear signal samples X⁽³⁾[n] and X⁽⁵⁾[n] from information of the transmitting side or receive the same from the transmitting side in operation 1410. Further, the receiving side receives a time axis self-interference signal y[n] including a non-linear signal from the transmitting side through an interference channel and extracts a frequency axis reception signal Y[n] from the reception signal y[n] in operation 1415. The relationship between the frequency axis reception signal Y[n], the frequency axis transmission signal X[n], and the non-linear signal samples X⁽³⁾[n] and X⁽⁵⁾[n] through PH modeling may be indicated by [Equation 13] below.

$$[ \begin{matrix}Y [ 1 ] \\ Y [ 2 ] \\ … \\ Y [ N - 1 ] \\ Y [ N ]\end{matrix} ] = {a}_{1} H [ \begin{matrix}X [ 1 ] \\ X [ 2 ] \\ … \\ X [ N - 1 ] \\ X [ N ]\end{matrix} ] + {a}_{3} H [ \begin{matrix}{X}^{( 3 )} [ 1 ] \\ {X}^{( 3 )} [ 2 ] \\ … \\ {X}^{( 3 )} [ N - 1 ] \\ {X}^{( 3 )} [ N ]\end{matrix} ] + {a}_{5} H [ \begin{matrix}{X}^{( 5 )} [ 1 ] \\ {X}^{( 5 )} [ 2 ] \\ … \\ {X}^{( 5 )} [ N - 1 ] \\ {X}^{( 5 )} [ N ]\end{matrix} ] \qquad [ Equation 13 ]$$

In [Equation 13], Y indicates a frequency axis digital signal corresponding to the reception signal, and X, X⁽³⁾ and X⁽⁵⁾ indicate a transmission signal and non-linear signal samples of the transmission signal in the frequency axis. N indicates the total number of samplings of the signal, and a₁, a₃, and a₅ indicate coefficients of the non-linear signal based on the result of PH modeling. H is a diagonal matrix, and each element indicates a coefficient of a multi-path channel in the frequency axis.

The receiving side performs a process of estimating H and a₁, a₃, and a₅ on the basis of [Equation 13]. That is, the receiving side may estimate the interference channel H and the coefficients a₁, a₃, and a₅ of the non-linear signal by using the already known signals and signal samples Y, X, X⁽³⁾, and X⁽⁵⁾ in operation 1420. For example, the estimation process of operation 1220 may apply the method used in the conventional channel estimation.

As described above, the process of estimating the non-linear signal of the self-interference channel passes through a process which is the same as the channel estimation process. However, there is difference from the conventional channel estimation scheme. While channel estimation considering only the linear signal is performed in the conventional channel estimation, a reference signal for channel estimation of the non-linear signal is generated in advance from a reference signal of the linear signal in order to estimate the non-linear signal in embodiments of the disclosure.

The receiving side acquires an estimation channel H′ of the channel H and estimation values of the non-linear component coefficients a′₁, a′₃, and a′₅ through the estimation process of operation 1420. The receiving side estimates a self-interference signal by using the acquired estimation channel H′ and estimation coefficients a′₁, a′₃, and a′₅ of the non-linear signal in operation 1425. For example, the receiving side may estimate the self-interference signal through [Equation 14] below by using the transmission signal and the non-linear signal samples X, X⁽³⁾, and X⁽⁵⁾ and the estimation channel H′ and estimation coefficients a′₁, a′₃, and a′₅ of the non-linear signal estimated in operation 1420.

a′₁H′X[n]+a′₃H′X⁽³⁾[n]+a′₅H′X⁽⁵⁾[n]+ [Equation 14]

[Equation 14] above shows a signal obtained after the transmitted self-interference signal is received by the receiving side, converted into a time axis digital signal while passing through the ADC, and then converted while passing through the EFT again, and the channel and non-linear coefficients acquired through the estimation process are used.

[Equation 14] above shows a signal obtained after the transmitted self-interference signal is received by the receiving side and then converted into a time axis digital signal while passing through the ADC, and the channel and non-linear coefficients acquired through the estimation process are used.

The receiving side removes the self-interference signal estimated in operation 1425 from the reception signal in order to receive a desired signal in operation 1430.

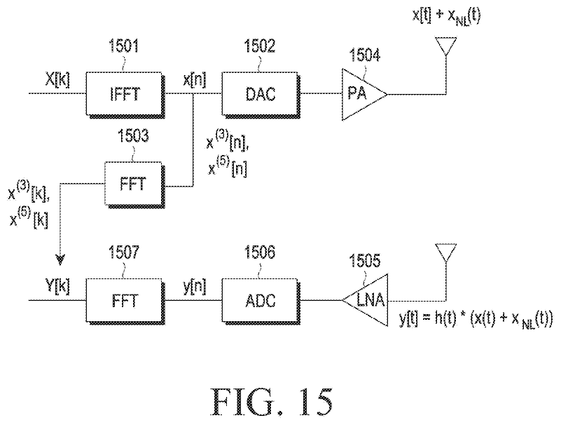

FIG. 15 illustrates the structure of a transceiver for performing frequency axis digital self-interference cancellation according to an embodiment of the disclosure.

Referring to FIG. 15, a frequency axis digital signal X[k] of the transmitting side is transferred to the receiving side. Further, the frequency axis digital signal X[k] of the transmitting side is converted into a time axis digital signal x[n] while passing through an IFFT 1501. The time axis digital signal x[n] is converted into time axis non-linear signal samples x⁽³⁾[n] and x⁽⁵⁾[n] while passing through a multiplier (not shown), converted into frequency axis non-linear signal samples X⁽³⁾[n] and X⁽⁵⁾[n] while passing through an FFT 1503, and transferred to the receiving side. Further, the time axis digital signal x[n] of the transmitting side is converted into a time axis analog signal x(t)+x_{NL}(t) including a non-linear signal While passing through a DAC 1502 and a PA 1504, passes through a radio channel through an antenna of the transmitting side, and then is received as a reception signal y(t) by an antenna of the receiving side through a radio channel. y(t) is converted into a time axis digital signal y[n] while passing through an LNA 1505 and an ADC 1506 of the receiving side. Further, the time axis digital signal y[n] is converted into a frequency axis digital signal Y[n] while passing through an FFT 1507 of the receiving side. The receiving side estimates the interference channel and the non-linear signal coefficients by using X[n], X⁽³⁾[n], X⁽⁵⁾[n], and Y[n] as described above and estimates the interference signal by using the estimated, interference channel and non-linear component coefficients. Further, the receiving side cancels self-interference by using the estimated interference signal.

### Embodiment 3

Embodiment 3 describes a method of correcting a time synchronization error when there is the time synchronization error according to a channel delay between the receiving side and the transmitting side in embodiment 1 and embodiment 2. Particularly, embodiment 3 describes a method of, when there is an integer-multiple error, correcting the same.

A transmission signal acts as self-interference to a reception signal in a device performing full-duplex transmission, and a self-interference signal is received through a radio channel. The radio channel includes multiple paths as described above, and thus the self-interference signal is delayed and received according to a transmission distance.

For example, when the distance between a transmitting side and a receiving side in one device is D_{SI,1}, a delay of τ_{SI,1} corresponding to D_{SI,1}/C is generated, which becomes a delay of the reception signal.

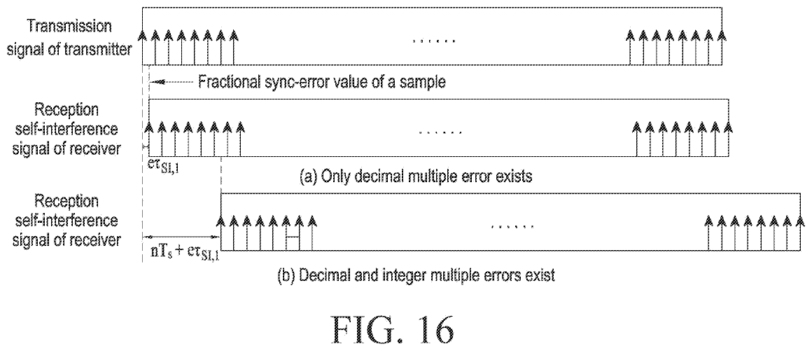

FIG. 16 illustrates a time synchronization error between a digital transmission signal of the transmitting side and a digital reception signal of the receiving signal according to an embodiment of the disclosure. In FIG. 16, arrows of the transmission signal and the reception signal are sample signals of the transmission signal and sample signals of the reception signal. FIG. 16 illustrates a time synchronization error generated in the self-interference signal and influence of the time synchronization error.

Referring to FIG. 16, in the figure showing the transmission signal of the transmitter, the x axis indicates the time and each arrow indicates a discrete signal before conversion through the DAC. Each arrow does not indicate a specific value and merely indicates that a signal to be transmitted is made at a specific time and is transmitted at predetermined intervals. At this time, a time interval between transmitted signals or a time interval between samples indicated by arrows is defined as Tₛ.

Referring to FIG. 16, in the figure showing a reception self-interference signal in the receiver within the same device as the transmitter or a device corresponding to a set performing both transmission and reception, the x axis indicates the time and the arrow indicates a received signal. Since a sample interval of transmitted signals is Tₛ, an interval of received self-interference signals is also Tₛ. Meanwhile, the signal transmitted by the device is received by the receiver via a radio transmission channel. Accordingly, as described above, the signal transmitted by the transmitter arrives at the receiver after τ_{SI,1}. Embodiment 3 describes the case in which there is only an effect of a direct path, and embodiment 4 below describes the case in which there is an effect of a reflective path as well as the direct path.

In FIG. 16, the time synchronization error value (a fractional sync-error value of a sample) is relevant to a delay τ_{SI,1} generated when the transmission signal reaches via a radio channel after actual transmission. When the delay τ_{SI,1} is shorter than Tₛ, a difference between the transmission signal of the transmitter and the reception signal of the receiver is a decimal multiple of Tₛ as illustrated in FIG. 16A. When τ_{SI,1} is longer than Tₛ, a difference between the transmission signal of the transmitter and the reception signal of the receiver is n times of Tₛ as well as a decimal multiple of Tₛ as illustrated in FIG. 16B. At this time, n is an integer satisfying an inequality such as [Equation 15] below.

nTₛ=<τ_{SI,1}<(n+1)Tₛ [Equation 15]

The decimal multiple difference between the reception signal and the transmission signal may have a value as shown in [Equation 16] below.

eτ_{SI,1}=τ_{SI,1}−nTₛ [Equation 16]

When there are decimal multiple and integer multiple errors of Tₛ as illustrated in FIG. 16B, the integer multiple error may be estimated using correlation between signals.

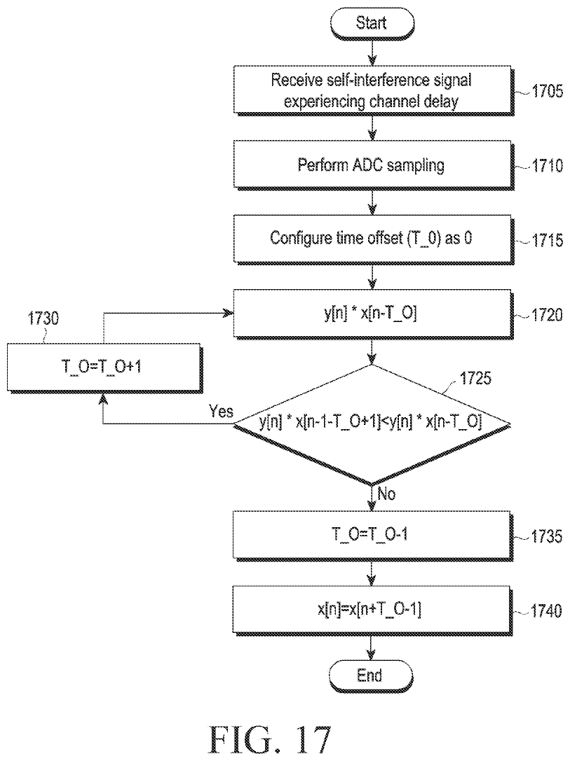

FIG. 17 illustrates a method of correcting a time synchronization error due to a channel delay by using the correlation between the reception signal and the transmission signal according to an embodiment of the disclosure. Particularly. FIG. 17 describes a method of correcting influence by an integer multiple error in the time synchronization error.

Referring to FIG. 17, the receiving side receives a self-interference signal y(t) experiencing a channel delay. The self-interference signal y(t) is a time axis analog signal and corresponds to a signal after a transmission signal x(t)+x_{NL}(t) including a non-linear signal of the transmitting side is received by the receiving side through an interference channel h. The receiving side performs ADC sampling on the received y(t) and convert the same into a digital signal y[n] in operation 1710. The receiving side configures a time offset (T_0) corresponding to the synchronization error value as 0 in operation 1715. The receiving side performs a convolution operation for the self-interference signal y[n] and a signal x[n−T_0] obtained by moving the transmission signal x[n] by T_0 in operation 1720. The receiving side compares the convolution operation result of y[n] and x[n−T_0] with the previous convolution operation result, that is, the convolution operation result of y[n] and x[n−T_0+1] in operation 1725. When the convolution operation result of y[n] and x[n−T_0] is greater than the convolution operation result of y[n] and x[n−T_0+1], the receiving side increases T_0 by 1 in operation 1730 and performs operation 1720 and operation 1725 for the increased T_0. When the convolution operation result of y[n] and x[n−T_0] is less than the convolution operation result of y[n] and x[n−T_0+1], the receiving side configures a value obtained by reducing the corresponding T_0 by 1 as the synchronization error value T_0 in operation 1735. The receiving side corrects the synchronization error according to the channel delay by correcting the transmission signal x[n] to a signal x[n+T_0] obtained by moving the signal x[n] by −T_0 by using the synchronization error value T_0 obtained in operation 1735 in operation 1740. The receiving side may perform the self-interference cancellation by using the signal x[n+T_0] of operation 1740.

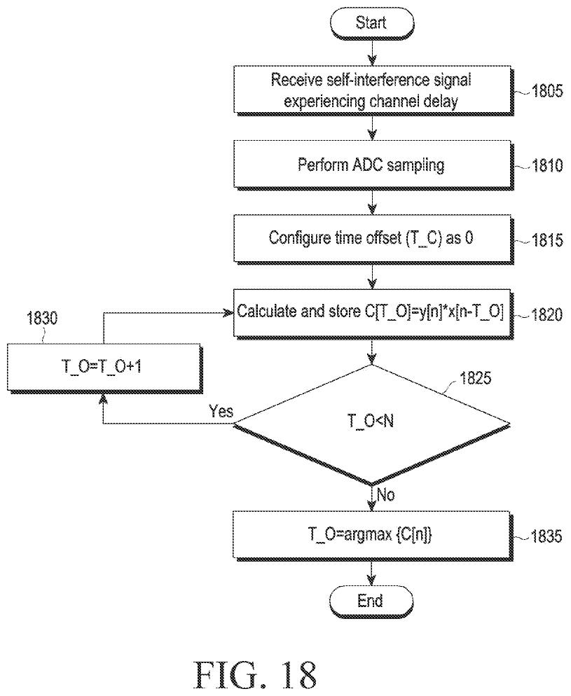

The embodiment of FIG. 17 may be preferred when the correlation value is not influenced by a desired signal other than noise or self-interference since the transmission side and the receiving side is sufficiently close to each other. Further, complexity and memory requirements are lower than an embodiment of FIG. 18 described below, the embodiment of FIG. 17 may be preferred and used by a BS having low computing power. In addition, the embodiment of FIG. 17 may be preferred when the BS uses many operation resources for other operations and there are small operation resources available for estimating the channel delay. Moreover, the embodiment of FIG. 17 may be preferred when the receiving side does not need to estimate the accurate self-interference channel delay.

FIG. 18 illustrates a method of correcting the time synchronization error due to the channel delay by using the correlation between the reception signal and the transmission signal according to another embodiment of the disclosure. Particularly, FIG. 18 describes a method of correcting influence by an integer multiple error in the time synchronization error.

Referring to FIG. 18, the receiving side receives a self-interference signal y(t) experiencing a channel delay in operation 1805. The self-interference signal y(t) is a time axis analog signal and corresponds to a signal after a transmission signal x(t)+x_{NL}(t) including a non-linear signal of the transmitting side is received by the receiving side through an interference channel h. The receiving side performs ADC sampling on the received y(t) and convert the same into a digital signal y[n] in operation 1810. The receiving side configures a time offset (T_0) corresponding to the synchronization error value as 0 in operation 1815. The receiving side performs the convolution operation for the self-interference signal y[n] and a signal x[n−T_0] obtained by moving the transmission signal x[n] by T_0 and stores the convolution result in C[T_0] in operation 1820. The receiving side determines whether T_0 is less than N which is the total number of ADC samplings in operation 1825. When T_0 is less than N on the basis of the determination result, the receiving side increases T_0 by 1 and performs operation 1815 and operation 1820 by using the increased T_0 in operation 1830. When T_0 is greater than 1, the receiving side determines T_0 having the largest value in C[T_0] as the synchronization error value in operation 1835. For example, in order to obtain a maximum value of C[T_0], the receiving side may use Arg max for C[T_0] or use a maximum value among the values obtained by calculating moving averages of samples of some C[T_0]. The receiving side corrects the synchronization error according to the channel delay by correcting the transmission signal x[n] to a signal x[n+T_0] obtained by moving the transmission signal x[n] by −T_0 by using the synchronization error value T_0 obtained in operation 1635 in operation 1840. The receiving side may perform the self-interference cancellation by using the signal x[n+T_0] of operation 1840.

The embodiment of FIG. 18 may be preferred when the transmission side and the receiving side are far away from each other or a desired signal, noise, and the like largely influence self-interference and thus the correlation value changes. Further, the embodiment of FIG. 18 may be preferred when accurate self-interference channel delay estimation is needed by the receiving side.

The signal used for estimating the channel delay in the embodiments of FIG. 17 and FIG. 18 may be a signal used for measuring a self-interference signal within the same node, a primary synchronization signal or a secondary synchronization signal for synchronization in another node, and a data signal for receiving information on another node, for example, a signal such as a PDSCH or a PDCCH. When the PSS/SSS for synchronization of another node is used, the transmitting side may more accurately estimate the delay of the self-interference channel. This is because it is advantageous for the correlation characteristic of the used signal to estimate the time delay reception signal. However, the corresponding signal is transmitted according to a predetermined period, and thus cannot be used all the time.

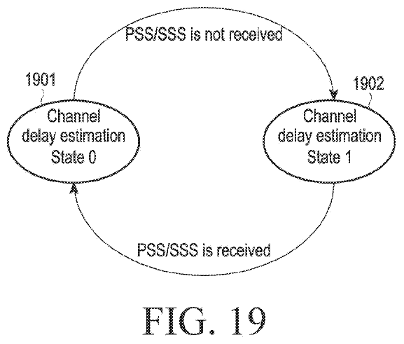

FIG. 19 illustrates a state of the receiving side performing channel delay estimation according to whether a self-interference signal includes a synchronization signal according to an embodiment of the disclosure.

Referring to FIG. 19, when the self-interference signal includes a PSS/SSS for another UE, the receiving side uses the PSS/SSS for channel delay estimation and defines the state of the receiving side in this case as state #0 1901. The receiving side may estimate the channel delay by using only the PSS/SSS among all signals. Further, the receiving side may estimate the channel delay by using data as well as the PSS/SSS. When the self-interference signal does not include the PSS/SSS for another UE, the receiving side uses a data signal, for example, a PDSCH and/or a PDCCH for channel delay estimation and defines the state of the receiving side in this case as state #1 1902. The receiving side may also estimate the channel delay by using only some signals and estimate the channel delay by using all the signals. For example, the receiving side may estimate the channel delay by using only the PSS/SSS in state #0 and estimate the channel delay by using all signals in state #1. Meanwhile, the PSS/SSS is received according to a predetermined period, and thus the channel delay is estimated while the state of the receiving side changes from state #0 to state #1 (or from state #1 to state #0).

The embodiment of FIG. 19 has been described from a viewpoint of the BS, and all of the signals PUCCH, PUSCH, SR, and SRS may be used from a viewpoint of the UE.

### Embodiment 4

Embodiment 4 describes a method of correcting the time synchronization error when there is the time synchronization error due to the channel delay between the receiving side and the transmitting side in embodiment 1 and embodiment 2. Particularly, embodiment 4 describes a method of correcting, the remaining decimal multiple error after the integer multiple error is corrected according to embodiment 3.

When a normal OFDM signal is used, influence by the decimal multiple error of the time axis sample is reflected in the channel or is small enough to be ignored and is not considered. However, since the self-interference signal is received from the transmitting side located near the receiving side, it is difficult to ignore influence thereof. Accordingly, a method of estimating and correcting the same is needed. Particularly, in the case of embodiment 1 in which self-interference cancellation is performed in the time axis, the performance may significantly decrease unless influence by the decimal multiple error is compensated.

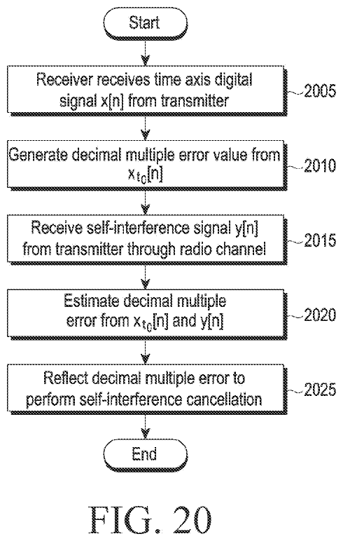

FIG. 20 illustrates a method of correcting the time synchronization error due to the channel delay of the reception signal and the transmission signal according to an embodiment of the disclosure. Particularly, FIG. 20 is a diagram illustrating a process of the operation of the receiving side for correcting the decimal multiple error in the time synchronization error.

In the embodiment of FIG. 20, it is assumed that the receiving side has corrected the integer multiple error in the time synchronization error of the self-interference signal according to embodiment 3 described above.

Referring to FIG. 20, the receiving side receives a time axis digital transmission signal x[n] from the transmitting side in operation 2005. For example, the receiving side may receive the transmission signal x[n] from the transmitting side by using a wired link, information within the CPU, a link connected within a PCB substrate, or another radio link. That is, the transmitting side performs an additional operation of transmitting a signal to the receiving side within the same node in order to remove a self-interference signal of a radio channel. A detailed procedure therefor is described below.

The receiving side generates a signal xₜ₀[n] which can be generated when a decimal multiple signal delay occurs on the basis of the received signal x[n] in operation 2010. For example, the receiving side may generate xₜ₀[n] by using a filter of a signal used by the transmitting side.

For example, when it is assumed that the filter used to generate an analog signal by the transmitting side is P(t), the analog signal x(t) corresponding thereto is as shown in [Equation 17] below.

$$x ( t ) = {\sum }_{i} P ( t ) ⋆ x [ i ] \qquad [ Equation 17 ]$$

Accordingly, the signal xₜ₀[n] having a decimal multiple error follows the signal shown in [Equation 18].

xₜ₀[n]=x(nTₛ−t₀) [Equation 18]

In [Equation 18], to is a value corresponding to the decimal multiple error and has a value between 0 and Tₛ corresponding to a sampling interval. Accuracy of the delay of the self-interference channel measured by the receiving side may be adjusted by controlling the number of values which t₀ can have. For example, when t₀ has two values of 0 and Tₛ/2, the maximum accuracy of the decimal multiple delay error of the self-interference channel that can be measured by the receiving side is Tₛ/2. When t₀ has M values, the maximum accuracy of the decimal multiple delay error of the self-interference channel that can be measured by the receiving side is Tₛ/M. As the value of M is greater, the accuracy of estimating the decimal multiple delay error of the self-interference channel becomes higher, but a memory size, calculation complexity, and the like to estimate the delay error of the self-interference channel may increase.

The receiving side receives the self-interference signal y[m] from the transmitting side through the self-interference channel in operation 2015. The self-interference channel means a radio channel between the transmitting side and the receiving side.

The receiving side estimates a decimal multiple error by using the signal xₜ₀[n] generated in operation 2010 and the self-interference signal y[n] received in operation 2015 in operation 2020. The receiving side removes a time synchronization error according to the delay of the self-interference channel by reflecting the estimated decimal multiple error to cancel the self-interference in operation 2025.

### Embodiment 5

Embodiment 5 describes a method of selecting embodiment 1 or embodiment 2 as necessary to perform digital self-interference cancellation.

In the case of embodiment 1, the digital self-interference cancellation may be performed in the time axis with relatively low complexity in comparison with embodiment 2 in which the digital self-interference cancellation is performed in the frequency axis. However, when a plurality of radio delay channels are experienced, embodiment 3 should be repeatedly performed to estimate the channels and estimate the channel delay time. Accordingly, as the number of channel delay times to be estimated for self-interference cancellation is greater, complexity of performing embodiment 1 increases. On the other hand, in the case of embodiment 2, the delay of the radio channel is reflected in a frequency channel, and thus additional channel estimation complexity due to multiple paths does not increase.

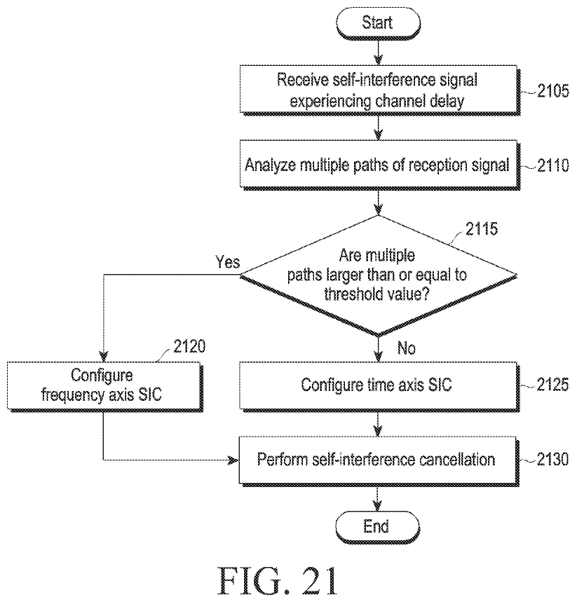

FIG. 21 illustrates a method of performing time axis digital self-interference cancellation and frequency axis digital self-interference cancellation in consideration of multiple paths according to an embodiment of the disclosure.

Referring to FIG. 21, the receiving side receives a self-interference signal from the transmitting side through a radio channel in operation 2105. The receiving side analyzes multiple paths which the self-interference signal experienced on the basis of the received self-interference signal in operation 2110. The receiving side determines whether the number of analyzed multiple paths is greater than or equal to a threshold. value in operation 2115. When the number of multiple paths is greater than or equal to the threshold value, the receiving side determines the performance of frequency axis digital self-interference cancellation of embodiment 2 in operation 2120. Further, when the number of multiple paths is less than the threshold value, the receiving side determines the performance of the time axis digital self-interference cancellation of embodiment 1 in operation 2125. For example, when the number of multiple paths which should be considered to cancel digital self-interference is 3 or more, the receiving side may perform frequency axis digital self-interference cancellation instead of time axis digital self-interference cancellation. The multiple paths which should be considered to mean that self-interference additionally generated when self-interference for the corresponding path(s) is generated is not large, in general, a path corresponding to self-interference less than the largest self-interference by 10 dB to 15 dB may not be considered. At this time, the value from 10 dB to 15 dB is randomly determined and can be adjusted as necessary in consideration of an environment of the self-interference channel.

The receiving side performs digital self-interference cancellation according to the self-interference cancellation scheme determined in operation 2120 or 2125 in operation 2130.

### Embodiment 6

Embodiment 6 describes a method of performing digital self-interference cancellation of embodiment 1 and/or embodiment 2 by re-estimating a self-interference channel and a non-linear signal by the receiving side when self-interference remaining in the receiving side is greater than or equal to a predetermined level in the case in which digital self-interference cancellation is performed according to embodiment 1 and/or embodiment 2.

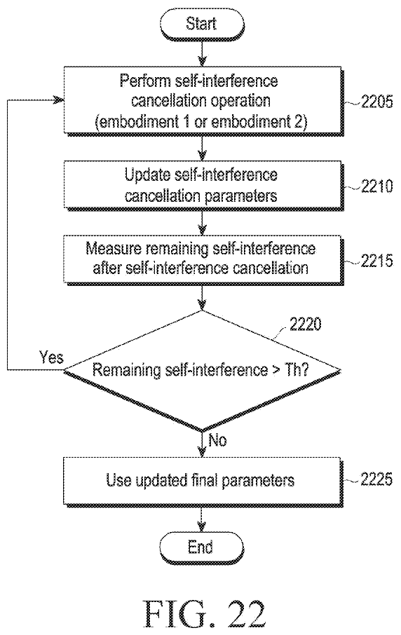

FIG. 22 illustrates a method of performing the digital self-interference cancellation again according to an embodiment of the disclosure.

Referring to FIG. 22, when receiving a self-interference signal from the transmitting side, the receiving side performs digital self-interference cancellation in operation 2205. For example, the receiving side may perform digital self-interference cancellation in consideration of embodiment 1, embodiment 2, and embodiment 5 described above.

The receiving side updates self-interference cancellation parameters H, a₁, a₃, and a₅ estimated in operation 2205 in operation 2210. For example, the receiving side may make new parameters H, a₁, a₃, and a₅ for the self-interference channel by adding H, a₁, a₃, and a₅ estimated after the performance of initial self-interference cancellation and H, a₁, a₃, and a₅ as estimated when self-interference cancellation for the remaining self-interference signals is performed.

The receiving side measures the remaining self-interference after self-interference cancellation in operation 2215. For example, the remaining self-interference may be measured through the strength of a signal obtained by attenuating the self-interference signal estimated according to embodiment 1 or embodiment 2 from the self-interference signal. The receiving side determines whether the remaining self-interference is greater than or equal to a threshold value (Th) in operation 2220. For example, it may be determined whether the strength of the signal obtained by attenuating the self-interference signal estimated according to embodiment 1 or embodiment 2 from the self-interference signal is greater than or equal to the threshold value. When the remaining self-interference is greater than or equal to the threshold value, the receiving side returns to operation 2205 and performs digital self-interference cancellation according to embodiment 1 or embodiment 2. For example, the receiving side may equally or alternately apply the self-interference cancellation of embodiment 1 or embodiment 2 to the signal obtained by attenuating the self-interference signal estimated according to embodiment 1 or embodiment 2 from the self-interference signal. For example, when the digital self-interference cancellation is performed initially in the time axis through embodiment 1, the time axis digital self-interference cancellation of embodiment 1 may be performed equally or frequency axis digital self-interference cancellation of embodiment 2 may be performed alternately for the signal obtained by attenuating the self-interference signal estimated according to embodiment 1 from the self-interference signal. Further, for example, when the digital self-interference cancellation is performed initially in the frequency axis through embodiment 2, the frequency axis digital self-interference cancellation of embodiment 2 may be performed equally or time axis digital self-interference cancellation of embodiment 1 may be performed alternately for the signal obtained by attenuating the self-interference signal estimated according to embodiment 2 from the self-interference signal.

When the remaining self-interference is less than the threshold value, the receiving side performs the digital self-interference cancellation for a desired signal by using updated final self-interference cancellation parameters in operation 2225.

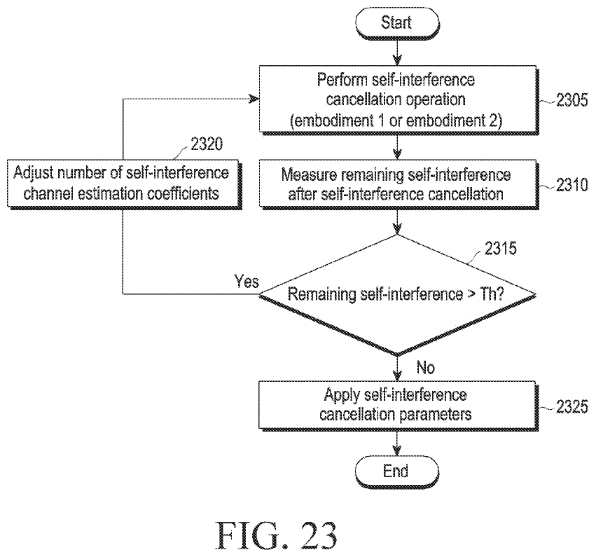

FIG. 23 illustrates the method of performing digital self-interference cancellation again according to another embodiment of the disclosure.

Referring to FIG. 23, when receiving a self-interference signal from the transmitting side, the receiving side performs digital self-interference cancellation in operation 2305. For example, the receiving side may perform digital self-interference cancellation in consideration of embodiment 1, embodiment 2, and embodiment 5 described above.

The receiving side measures the remaining self-interference after self-interference cancellation in operation 2310. For example, the remaining self-interference may be measured through the strength of a signal obtained by attenuating the self-interference signal estimated according to embodiment 1 or embodiment 2 from the self-interference signal. The receiving side determines whether the remaining self-interference is greater than or equal to a threshold value (Th) in operation 2315. For example, it may be determined whether the strength of the signal obtained by attenuating the self-interference signal estimated according to embodiment 1 or embodiment 2 from the self-interference signal is greater than or equal to the threshold value. When the remaining self-interference is greater than or equal to the threshold value, the receiving side adjusts the number of self-interference cancellation parameters in operation 2320. For example, the receiving side increases the number of coefficients estimating a non-linear signal in the self-interference cancellation parameters. For example, the transmitting side may estimate a non-linear signal coefficient a₀ by using only the transmission signal x[n] in initial self-interference cancellation, estimate non-linear signal coefficients a₀ and a₃ by using the transmission signal x[n] and a third-degree non-linear signal sample x⁽³⁾[n] in second self-interference cancellation, and estimate non-linear signal coefficients a₀, a₃, and a₅ by using the transmission signal x[n], the third-degree non-linear signal sample x⁽³⁾[n], and a fifth-degree non-linear signal sample x⁽⁵⁾[n] in third self-interference cancellation.

The receiving side returns to operation 2305 by using the number of self-interference cancellation parameters adjusted in operation 2320 and performs digital self-interference cancellation for the self-interference signal according to embodiment 1 or embodiment 2.

When the remaining self-interference is less than the threshold value, the receiving side performs the digital self-interference cancellation for a desired signal by using the adjusted final self-interference cancellation parameters in operation 2325.

### Embodiment 7

Embodiment 7 illustrates a structure of a transmitter and a method of applying a digital self-interference cancellation method according to a transmission signal transferring method for estimating a self-interference signal. In the case of embodiment 1 and embodiment 2 described above, it is assumed that the receiving side receives the signal, that is, the transmission signal used for digital self-interference cancellation from a digital calculation unit. At this time, when the receiving side receives the transmission signal from the digital calculation unit of the transmitting side, non-linearity due to an RF element may not be reflected in the transmission signal.

Embodiment 7 describes a self-interference signal cancellation method according to the type of a signal for cancelling self-interference which the transmitting side transmits to the receiving side. For example, the receiving side may adjust a coefficient for estimating self-interference according to whether non-linearity of the signal for cancelling the self-interference received from the transmitting side is reflected.

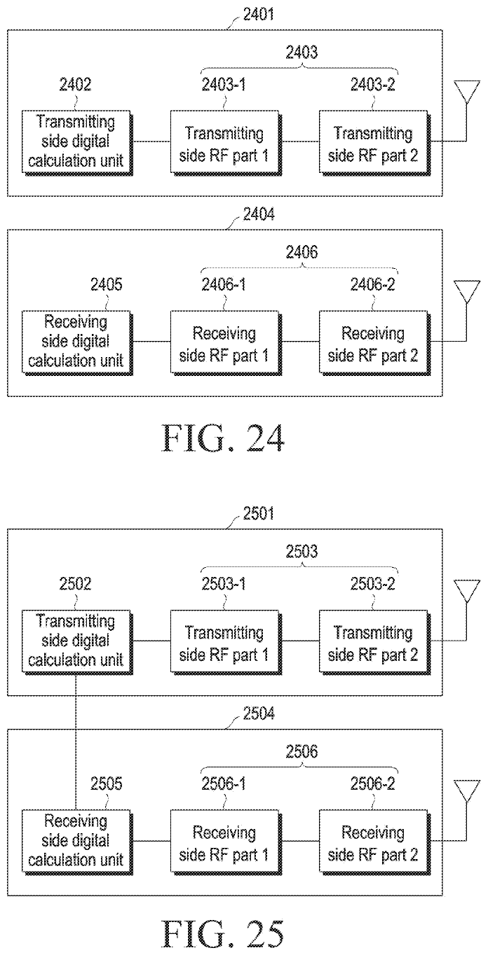

FIG. 24 illustrates a configuration of the transmitting side and the receiving side within the same node according to an embodiment of the disclosure.

Referring to FIG. 24, a transmitting side 2401 includes a digital calculation unit 2402 and an RF part 2403. Further, a receiving side 2404 includes a digital calculation unit 2405 and an RF part 2406. The digital calculation unit 2402 of the transmitting side 2401 and the digital calculation unit 2406 of the receiving side 2405 are elements corresponding to a baseband unit or a digital unit of the normal communication system and perform digital calculation. Further, the RF part 2403 of the transmitting side 2201 and the RF part 2406 of the receiving side 2404 are elements for changing a signal existing in the baseband into an RF signal. The RF part 2403 of the transmitting side 2401 may include RF part 1 2403-1 and RF part 2 2403-2. Further, the RF part 2406 of the receiving side 2404 may include RF part 1 2406-1 and RF part 2 2406-2. Separation of the RF part into RF part 1 and RF part 2 in FIG. 24 is because some elements may be separated and realized according to implementation. For example, when an IF is used, some elements of the IF may be included in RF part 1 and elements corresponding to the remaining RFs may be included in RF part 2. When the structure of hybrid beamforming is considered, a part for generating an RF signal after digital beamforming may correspond to RF part 1 and thereafter a part for generating analog beamforming may corresponding to RF part 2. Accordingly, it should be understood that RF part 1 and RF part 2 do not correspond to specific elements but are elements including some of non-linear signals reflected during digital self-interference in FIG. 24.

FIG. 25 illustrates a connection structure between the transmitting side and the receiving side within the same node according to an embodiment of the disclosure.

Referring to FIG. 25, a digital calculation unit 2502 of a transmitting side 2501 and a digital calculation unit 2505 of a receiving side 2504 are directly connected. At this time, the ‘connection’ includes all types of connections through which information can be transmitted as well as wired and wireless connections. The transmitting side 2501 may directly transfer information to the receiving side digital calculation unit 2505 of the receiving side 2504 through the transmitting side digital calculation unit 2502.

For example, according to embodiment 1, a time axis digital transmission signal x[n] of the transmitting side 2501 may be directly transferred to the digital calculation unit 2505 of the receiving side 2504 through the digital calculation unit 2502 of the transmitting side 2501. Further, according to embodiment 1, non-linear signal samples such as time axis signal samples x⁽³⁾[n],x⁽⁵⁾[n],x⁽⁷⁾[n], . . . for estimating non-linear signals generated while the time axis digital transmission signal x[n] experiences the RF part 2503 of the transmitting side 2501 may be directly transferred to the digital calculation unit 2505 of the receiving side 2504 through the digital calculation unit 2502 of the transmitting side 2501.

In another example, according to embodiment 2, the frequency axis digital transmission signal X[n] of the transmitting side 2501 may be directly transferred to the digital calculation unit 2505 of the receiving side 2504 through the digital calculation unit 2502 of the transmitting side 2501. According to embodiment 2, non-linear signal samples such as frequency axis signal samples X⁽³⁾[n],X⁽⁵⁾[n],X⁽⁷⁾[n], . . . for estimating non-linear signals generated while the time axis digital transmission signal x[n] experiences the RF part 2503 of the transmitting side 2501 may be directly transferred to the receiving side digital calculation unit 2505 of the receiving side 2504 through the transmitting side digital calculation unit 2502.

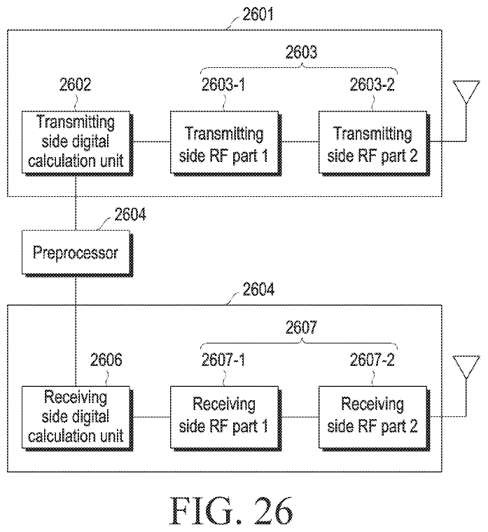

FIG. 26 illustrates the connection structure between the transmitting side and the receiving side within the same node according to another embodiment of the disclosure.

Referring to FIG. 26, a digital calculation unit 2602 of a transmitting side 2601 is connected to a digital calculation unit 2606 of a receiving side 2605 through a preprocessor 2604. At this time, the ‘connection’ includes all types of connections through which information can be transmitted as well as wired and wireless connections. The preprocessor 2604 severs to generate a signal to be transferred to the digital calculation unit 2606 of the receiving side 2605 from a signal generated by the digital calculation unit 2602 of the transmitting side 2601.

For example, the preprocessor 2604 may generate time axis non-linear signal samples x⁽³⁾[n],x⁽⁵⁾[n],x⁽⁷⁾[n], . . . used to estimate the self-interference signal in embodiment 1 from the time axis digital transmission signal x[n] of the transmitting side 2601. Further, the preprocessor 2604 may extract the time axis digital transmission signal x[n] of the transmitting side 2601 used to estimate the self-interference signal in embodiment 1 from the frequency axis digital transmission signal X[n] of the transmitting side 2601.

In another embodiment, the preprocessor 2604 may extract frequency axis non-linear signal samples X⁽³⁾[n],X⁽⁵⁾[n],X⁽⁷⁾[n], . . . used to estimate the self-interference signal in embodiment 2 from the time axis digital transmission signal x[n] of the transmitting side 2601. Further, the preprocessor 2604 may extract the frequency axis digital transmission signal X[n] of the transmitting side 2601 used to estimate the self-interference signal in embodiment 2 from the time axis digital transmission signal x[n] of the transmitting side 2601.

In another example, the preprocessor 2604 may serve to compensate for the delay of self-interference due to the delay of a self-interference radio channel according to embodiment 3 and embodiment 4.

Elements of FIG. 25 and FIG. 26 may be the structure included in one hardware but may be understood to be separated for each detailed element as necessary. For example, if a transmitter and a receiver of different nodes can share self-interference information through information sharing lines of the transmitter and the receiver, they can perform a self-interference cancellation function as one node.

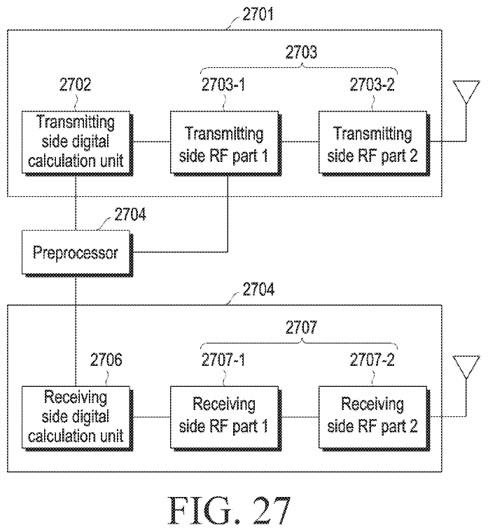

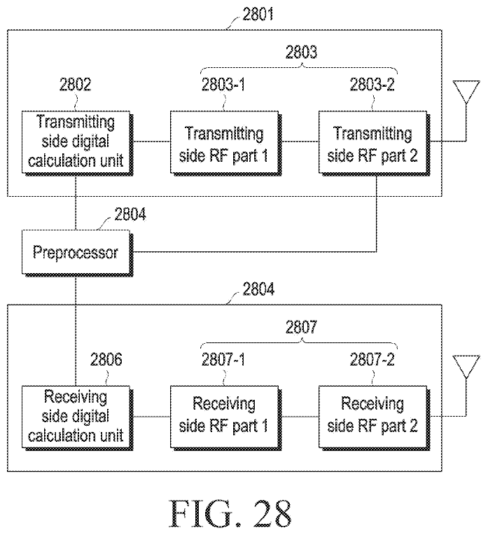

Meanwhile, the structure including the preprocessor may be expanded as illustrated in FIG. 27 and FIG. 28 below.

FIG. 27 illustrates the connection structure between the preprocessor, the transmitting side, and the receiving side according to an embodiment of the disclosure. The structure of FIG. 27 illustrates the structure in which the preprocessor is additionally connected to RF part 1 of the transmitting side in the structure of FIG. 26.

Referring to FIG. 27, a digital calculation unit 2701 of a transmitting side 2702 is connected to a digital calculation unit 2704 of a receiving side 2705 through a preprocessor 2704. Further, the preprocessor 2704 has connectivity with RF part 1 2703-1 of the transmitting side 2701 as well as with the digital calculation unit 2703 of the transmitting side 2701 and with the digital calculation unit 2706 of the receiving side 2705. The preprocessor 2704 may reflect influence of RF part 1 2703-1 of the transmitting side 2701 in the digital calculation unit 2706 of the receiving side 2705 and transfer a modified time axis digital transmission signal x′[n] of the transmitting side 2701 or a modified frequency axis digital transmission signal X′[n] of the transmitting side 2701. The digital calculation unit 2706 of the receiving side 2705 may perform the self-interference cancellation by using the modified time axis digital transmission signal x′[n] or the modified frequency axis digital transmission signal X′[n].

FIG. 28 illustrates the connection structure between the preprocessor, the transmitting side, and the receiving side according to another embodiment of the disclosure. The structure of FIG. 28 illustrates the structure in which the preprocessor is additionally connected to RF part 2 of the transmitting side in the structure of FIG. 26.

Referring to FIG. 28, a digital calculation unit 2801 of a transmitting side 2801 is connected to a digital calculation unit 2804 of a receiving side 2805 through a preprocessor 2804. Further, the preprocessor 2804 has connectivity with RF part 2 2803-2 of the transmitting side 2801 as well as with the digital calculation unit 2803 of the transmitting side 2801 and with the digital calculation unit 2806 of the receiving side 2805. The preprocessor 2804 may reflect influence of RF part 2 2803-2 of the transmitting side 2801 in the digital calculation unit 2806 of the receiving side 2805 and transfer a modified time axis digital transmission signal x″[n] of the transmitting side 2801 or a modified frequency axis digital transmission signal X″[n] of the transmitting side 2801. The digital calculation unit 2806 of the receiving side 2805 may perform the self-interference cancellation by using the modified time axis digital transmission signal x″[n] or the modified frequency axis digital transmission signal X″[n] of the transmitting side 2801.

When the signal for removing the modified self-interference signal in FIG. 27 and FIG. 28 is transferred to the digital calculation unit of the receiving side, some or all of the processes of estimating non-linear signal coefficients by the receiving side may be omitted.

For example, when the preprocessor transfers some of the non-linear signals generated due to RF elements of the transmitting side to the digital calculation unit of the receiving side in FIG. 27, the digital calculation unit of the receiving side may estimate only a channel component h or H to operate.

In another example, when the preprocessor transfers all of the non-linear signals generated due to RF elements of the transmitting side to the digital calculation unit of the receiving side in FIG. 28, the digital calculation unit of the receiving side may estimate only a channel component h or H to operate.

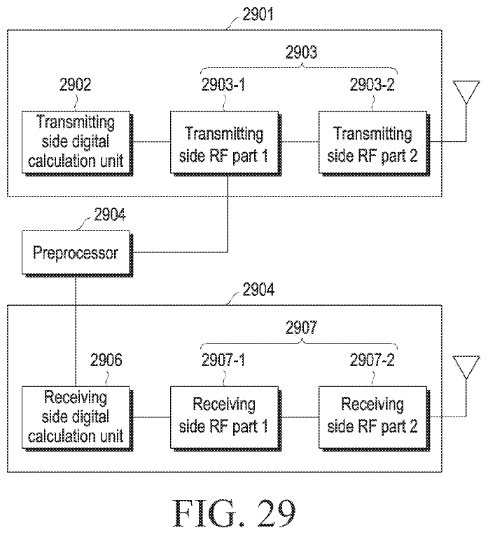

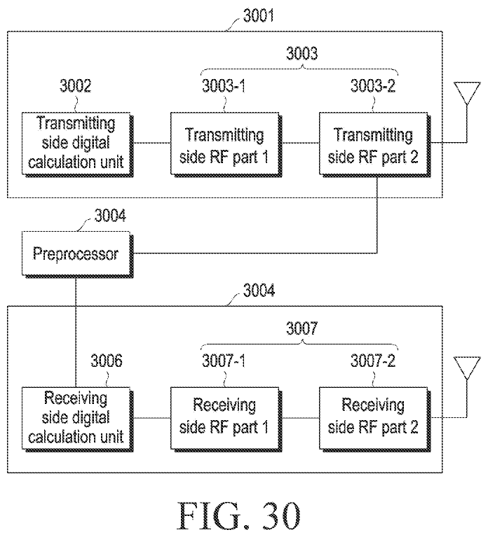

Further, through the structure of FIG. 27 or FIG. 28, the preprocessor may transfer coefficients of the non-linear signals generated by the transmitting side in the processed form to the receiving side. For example, a₂, a₃, a₅, and a₇ indicating coefficients of the non-linear signals in embodiment 1 and embodiment 2 may be estimated by the preprocessor and transmitted to the receiving side. Through the structure of FIG. 27 and FIG. 28, the preprocessor may transfer a digital transmission signal of the transmitting side, for example, a time axis digital transmission signal x[n] or a frequency axis digital transmission signal X[n] to the receiving side along with the coefficients of the non-linear signals. Meanwhile, in the structure of FIG. 27 and FIG. 28, the following structure of FIG. 29 and FIG. 30 in which the preprocessor receives the signal from the RF part of the transmitting side without receiving the signal from the digital calculation unit of the transmitting side, processes the signal, and transfers the signal to the digital calculation unit of the receiving side is possible. In the structure of FIG. 29 and FIG. 30, the receiving side assumes reception of a signal including some or all of the non-linear signals of self-interference to perform digital self-interference cancellation.

For example, according to embodiment 1 and embodiment 2, in digital self-interference cancellation, the time axis digital transmission signal x[n] or the frequency axis digital transmission signal X[n] may be replaced with and use the signal obtained by changing an RF signal of the transmitting side to a digital signal by the preprocessor rather than the digital signal of the transmitting side. Transmission of the signal is also possible through the structure of FIG. 26 and FIG. 27.

At this time, when the transmitting side transfers the signal including some of the non-linear signals of the self-interference signal to the digital calculation unit of the receiving side, the transmitting side may transfer the result due to the non-linear signals generated from some RF elements to the receiving side according to the structure of FIG. 27 and FIG. 29 below and the digital calculation unit of the receiving side may not estimate the non-linear signals by RF part 1 of the transmitting side. That is, the receiving side may model and estimate only influence by the non-linear signals due to RF part 2 of the transmitting side.

Further, when the transmitting side transfers all of the non-linear signals of the self-interference signal to the digital calculation unit of the receiving side, the transmitting side may transfer the result of the non-linear signals generated by the RF element to the receiver according to the structure of FIG. 28 and FIG. 30 below and the digital calculation unit of the receiving side may not estimate the non-linear signals by the RF part of the transmitting side. That is, the receiving side may perform digital self-interference cancellation without modeling the non-linear signals.

FIG. 29 illustrates the connection structure between the preprocessor, the transmitting side, and the receiving side according to another embodiment of the disclosure. The structure of FIG. 29 indicates the structure in which the preprocessor is connected only to RF part 1 of the transmitting side in the structure of FIG. 27.

Referring to FIG. 29, instead of a digital calculation unit 2902 of a transmitting side 2901, RF part 1 2903-1 of the transmitting side 2901 is connected to a digital calculation unit 2906 of a receiving side 2905 through a preprocessor 2904. The preprocessor 2904 may transfer a time axis digital transmission signal x′[n] or a frequency axis digital transmission signal X′[n] obtained by converting the RF signal received from RF part 1 2903-1 of the transmitting side 2901 into a digital signal to the digital calculation unit 2906 of the receiving side 2905. The digital calculation unit 2906 of the receiving side 2905 may perform the self-interference cancellation by using the time axis digital transmission signal x′[n] or the frequency axis digital transmission signal X′[n] received from the preprocessor 2904.

FIG. 30 illustrates the connection structure between the preprocessor, the transmitting side, and the receiving side according to another embodiment of the disclosure. The structure of FIG. 30 indicates the structure in which the preprocessor is connected only to RF part 2 of the transmitting side in the structure of FIG. 28.

Referring to FIG. 30, instead of a digital calculation unit 3002 of a transmitting side 3001, RF part 2 3003-2 of the transmitting side 3001 is connected to a digital calculation 3006 of a receiving side 3005 through a preprocessor 3004. The preprocessor 3004 may transfer a time axis digital transmission signal x″[n] or a frequency axis digital transmission signal X″[n] obtained by converting the RF signal received from RF part 2 3003-2 of the transmitting side 3001 into a digital signal to the digital calculation unit 3006 of the receiving side 3005. The digital calculation unit 3006 of the receiving side 3005 may perform the self-interference cancellation by using the time axis digital transmission signal x″[n] or the frequency axis digital transmission signal X″[n] received from the preprocessor 3004.

The structure of FIG. 27 and FIG. 29 in which some RF non-linear signals are transmitted and the structure of FIG. 28 and FIG. 30 in which all RF non-linear signals are transmitted should be determined in consideration of complexity of implementation and a gain of the performance. For example, in the transmitting side using a plurality of antennas for several beamforming, when the structure before separation of signals to multiple antennas is RF part 1 and a part for configuring beams by multiple antennas thereafter is RF part 2, if the number of lines required for the structure in which RF part 1 transmits the signal to the preprocessor is L, the number of lines for transmission from RF part 2 increases to L X the number of antennas. That is, when the preprocessor receives the signal from RF part 2, accuracy of estimating the self-interference signal increases and thus a gain of the performance is improved, but complexity increases as L and the number of antennas increase and thus the gain of the performance may more decrease at a specific time point compared to the case in which the preprocessor receives the signal from RF part 1.

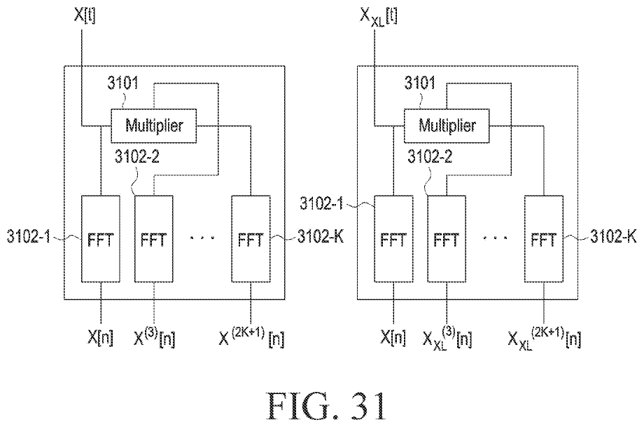

FIG. 31 illustrates the internal structure of the preprocessor according to an embodiment of the disclosure.

Referring to FIG. 31, the preprocessor includes a multiplier 3101 and a plurality of FFTs 3102-1, 3102-2, . . . 3102-k in order to convert a time axis signal of the transmitting side into a frequency axis signal. The preprocessor calculates the correlation of all frequency axis signals in order to estimate non-linear signals configured by the RF from frequency axis signals using the multiplier and the plurality of FFTs. This can be equally applied to x_{NL}(t) including a non-linear signal and x(t) which does not include a non-linear component. Meanwhile, FIG. 29 illustrates only some of the elements of the preprocessor, and the elements of the preprocessor are not limited thereto.

### Embodiment 8

Embodiment 8 describes information which the transmitting side should transmit to the receiving side or the processor or which the preprocessor should transmit to the receiving side in order to implement embodiment 1, embodiment 2, and embodiment 3.

When time axis self-interference cancellation is performed according to embodiment 1, the receiving side needs a transmission signal of the transmitting side. Accordingly, the receiving side basically receives the time axis transmission signal x(t) form the transmitting side.

When time axis self-interference cancellation is performed according to embodiment 1, the transmitting side may transfer the transmission signal x(t) or the transmission signal x_{NL}(t) including the non-linear signal to the preprocessor in consideration of the preprocessor according to embodiment 7.

When time axis self-interference cancellation is performed according to embodiment 1, the preprocessor may transfer the transmission signal x(t) of the transmitting side or the transmission signal x_NL(t) including the non-linear signal to the receiving side. The preprocessor may transfer non-linear signal coefficients a₁, a₃, and a₅ estimated from x_NL(t) to the receiving side. Further, x⁽³⁾(t),x⁽⁵⁾(t),x⁽⁷⁾(t) made from x(t) may be directly transferred to the receiving side. According to embodiment 1, as a means for estimating the non-linear signal generated after not only x[n] but also a self-interference signal experience the RF part, non-linear signal samples x⁽³⁾[n], x⁽⁵⁾[n], and x⁽⁷⁾[n] may be transferred to the receiving side.

When frequency axis self-interference cancellation is performed according to embodiment 2, the receiving side needs the transmission signal of the transmitting side. Accordingly, the receiving side basically receives the frequency axis transmission signal X[n] from the transmitting side.

When frequency axis self-interference cancellation is performed according to embodiment 2, the transmitting side may transfer the transmission signal x(t) or the transmission signal x_{NL}(t) including the non-linear signal to the preprocessor in consideration of the preprocessor according to embodiment 7.

When frequency axis self-interference cancellation is performed according to embodiment 2, the preprocessor may transfer the transmission signal X[n] of the transmitting side or a non-linear signal sample X^{(N)} indicating or the non-linear signal to the receiving side in consideration of the preprocessor according to embodiment 7. Further, non-linear signal coefficients a_1, a_3, and a_ 5 estimated from X^{(N)} may be transferred to the receiving side. As a means for estimating the non-linear signal generated after not only X[n] but also the transmission signal experience the RF part according to embodiment 2, non-linear signal samples X⁽³⁾[n], X⁽⁵⁾[n], and X⁽⁷⁾[n] may be transferred to the receiving side.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. A singular firm of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used herein, the term “module” may include a unit implemented in hardware, software, or firmware, and may be interchangeably used with other terms, for example, “logic,” “logic block,” “component,” or “circuit”. The “module” may be a minimum unit of a single integrated component adapted to perform one or more functions, or a part thereof. For example, according to an embodiment, the “module” may be implemented in the form of an application-specific integrated circuit (ASIC).

Various embodiments as set forth herein may be implemented as software (e.g., a program) including one or more instructions that are stored in a storage medium (e.g., an internal memory or external memory) that is readable by a machine (e.g., an electronic device). For example, a processor of the machine (e.g., the electronic device) may invoke at least one of the one or more stored instructions from the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities. According to various embodiments, one or more of the above-described elements may be omitted, or one or more other elements may be added. Alternatively or additionally, a plurality of elements (e.g., modules or programs) may be integrated into a single element, in such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof.

1. A method of performing digital self-interference cancellation by a transmission/reception device comprising a transmitting side and a receiving side in a full-duplex system, the method comprising
acquiring a time axis digital transmission signal generated by the transmitting side;
receiving a reception signal comprising a self-interference signal received through a self-interference channel between the transmitting side and the receiving through the receiving side;
extracting at least one time axis non-linear signal sample for estimating the self-interference channel and at least one non-linear signal coefficient of the self-interference signal from the time axis digital transmission signal;
converting the time axis digital transmission signal into a frequency axis digital transmission signal and the at least one tune axis non-linear signal sample into at least one frequency axis non-linear signal sample;
converting the reception signal into a frequency axis digital reception signal;
estimating channel information of the self-interference channel and at least one non-linear signal coefficient of the self-interference signal, based on the frequency axis digital transmission signal, the at least one frequency axis non-linear signal sample, and the frequency axis digital reception signal;
estimating the self-interference signal, based on the estimated channel information and the estimated at least one non-linear signal coefficient; and
performing digital self-interference cancellation for the frequency axis digital reception signal by using the estimated self-interference signal.

2. The method of claim 1, wherein converting the time axis digital transmission signal into the frequency axis digital transmission signal and the at least one time axis non-linear signal sample into at least one frequency axis non-linear signal sample comprises:
analyzing multiple paths of the reception signal;
comparing a number of the analyzed multiple paths with a threshold value; and
in case that the number of the analyzed multiple paths is greater than or equal to the threshold value, converting the time axis digital transmission signal into the frequency axis digital transmission signal, and the at least one time axis non-linear signal sample into at least one frequency axis non-linear signal sample.

3. The method of claim 1, wherein performing the digital self-interference cancellation for the frequency axis digital reception signal by using the estimated self-interference signal comprises:
updating the at least one non-linear signal coefficients for the estimated self-interference signal;
comparing a strength of a signal obtained by attenuating the estimated self-interference signal from the frequency axis digital reception signal with a threshold value;
in case that the strength of the signal obtained by attenuating the estimated self-interference signal from the frequency axis digital reception signal is greater than or equal to the threshold value, estimating at least one non-linear signal coefficient for the signal obtained by attenuating the estimated self-interference signal from the frequency axis digital reception signal; and
in case that the strength of the signal obtained by attenuating the estimated self-interference signal from the frequency axis digital reception signal is less than the threshold value, estimating the self-interference signal, based on the estimated self-interference channel and the updated non-linear signal coefficient and performing the digital self-interference cancellation for the frequency axis digital reception signal by using the estimated self-interference signal.

4. The method of claim 1, wherein performing the digital self-interference cancellation for the frequency axis digital reception signal by using the estimated self-interference signal comprises:
comparing a strength of a signal obtained by attenuating the estimated self-interference signal from the frequency axis digital reception signal with a threshold value;
in case that the strength of the signal Obtained by attenuating the estimated self-interference signal from the frequency axis digital reception signal is greater than or equal to the threshold value, adjusting a number of the non-linear signal coefficients and estimating the self-interference signal, based on the adjusted number of the non-linear signal coefficients; and
in case that the strength of the signal obtained by attenuating the estimated self-interference signal from the frequency axis digital reception signal is less than the threshold value, performing the digital self-interference cancellation for the frequency axis digital reception signal by using the estimated self-interference signal.

5. The method of claim 1, further comprising:
correcting a time synchronization error for the time axis digital transmission signal.

6. The method of claim 5, wherein correcting the time synchronization error comprises:
configuring an initial value of a time offset as 0;
converting the reception signal into a time axis digital reception signal;
performing a convolution operation for signals delayed from the time axis digital reception signal and the time axis digital transmission signal by the time offset;
comparing a result of the convolution operation for the signals delayed from the time axis digital reception signal and the time axis digital transmission signal by the time offset with a result of the convolution operation for signals delayed from the time axis digital reception signal and the time axis digital transmission signal by a value less than the time offset by 1;
in case that the result of the convolution operation for the signals delayed from the time axis digital reception signal and the time axis digital transmission signal by the time offset is greater than the result of the convolution operation for signals delayed from the time axis digital reception signal and the time axis digital transmission signal by the value less than the time offset by 1, increasing the time offset by 1 and comparing a result of the convolution operation for signals delayed from the time axis digital reception signal and the time axis digital transmission signal by a value increased from the time offset by 1 with a result of the convolution operation for signals delayed from the time axis digital reception signal and the time axis digital transmission signal by the time offset; and
in case that the result of the convolution operation for the signals delayed from the time axis digital reception signal and the time axis digital transmission signal by the time offset is less than the result of the convolution operation for signals delayed from the time axis digital reception signal and the time axis digital transmission signal by the value less than the time offset by 1, configuring the value less than the time offset by 1 as a time synchronization error value and correcting the time synchronization error for the time axis digital transmission signal by using the configured time synchronization error value.

7. The method of claim 5, wherein the correcting of the time synchronization error comprises:
configuring an initial value of a time offset as 0;
converting the reception signal into a time axis digital reception signal;
performing a convolution operation for signals delayed from the time axis digital reception signal and the time axis digital transmission signal by the time offset;
storing a result of the convolution operation for the signals delayed from the time axis digital reception signal and the time axis digital transmission signal by the time offset;
comparing the time offset and a value corresponding to a total number of samples for the time axis digital transmission signal;
in case that the time offset is less than the value corresponding to the total number of samples for the time axis digital transmission signal, increasing the time offset by 1, performing the convolution operation for signals delayed from the time axis digital reception signal and the time axis digital transmission signal by a value increased from the time offset by 1, and storing a result of the convolution operation for the signals delayed from the time axis digital reception signal and the time axis digital transmission signal by the value increased from the time offset by 1; and
in case that the time offset is greater than the value corresponding to the total number of samples for the time axis digital transmission signal, configuring a time offset value corresponding to an operation result having a maximum value among stored at least one operation result as a time synchronization error value and correcting the time synchronization error for the time axis digital transmission signal by using the configured time synchronization error value.

8. The method of claim 1, further comprising:
determining whether a time synchronization signal is included in the reception signal;
in case that the time synchronization signal is included in the reception signal, correcting a time synchronization error of the reception signal by using the time synchronization signal; and
in case that the time synchronization signal is not included in the reception signal, correcting the time synchronization error of the reception signal by using a data signal included in the reception signal.

9. The method of claim 1, wherein the generating of the at least one time axis non-linear signal sample comprises:
converting the reception signal into a time axis digital reception signal;
approximating the time axis digital reception signal as a polynomial for the time axis digital transmission signal; and
configuring respective terms of the approximated polynomial as the at least one time axis non-linear signal samples,

10. The method of claim 1, wherein, in case that the frequency axis digital reception signal is approximated as a polynomial for the frequency axis digital transmission signal, the non-linear coefficients are correlated to at least one term of the approximated polynomial.

11. A transmission/reception apparatus performing digital self-interference cancellation in a full-duplex system, the transmission/reception apparatus comprising:
a transmitter;
a receiver; and
a controller configured to:
acquire a time axis digital transmission signal generated by the transmitter;
control the receiver to receive a reception signal comprising a self-interference signal received through a self-interference channel between the transmitter and the receiver through the receiver;
extract at least one time axis non-linear signal sample for estimating the self-interference channel and at least one non-linear signal coefficient of the self-interference signal from the time axis digital transmission signal;
convert the time axis digital transmission signal into a frequency axis digital transmission signal and the at least one time axis non-linear signal sample into at least one frequency axis non-linear signal sample;
convert the reception signal into a frequency axis digital reception signal and estimate channel information of the self-interference channel and at least one non-linear signal coefficient of the self-interference signal, based on the frequency axis digital transmission signal, the at least one frequency axis non-linear signal sample, and the frequency axis digital reception signal;
estimate the self-interference signal, based on the estimated channel information and the estimated at least one non-linear signal coefficient; and
perform digital self-interference cancellation for the frequency axis digital reception signal by using the estimated self-interference signal.

12. The transmission/reception apparatus of claim 11, herein the controller is further configured to:
analyze multiple paths of the reception signal;
compare a number of the analyzed multiple paths with a threshold value; and
in case that the number of the analyzed multiple paths is greater than or equal to the threshold value, convert the time axis digital transmission signal into the frequency axis digital transmission signal and the at least one time axis non-linear signal sample into at least one frequency axis non-linear signal sample.

13. The transmission/reception apparatus of claim 11, wherein the controller is further configured to:
update the at least one non-linear signal coefficients for the estimated self-interference signal;
compare a strength of a signal obtained by attenuating the estimated self-interference signal from the frequency axis digital reception signal with a threshold value;
in case that the strength of the signal obtained by attenuating the estimated self-interference signal from the frequency axis digital reception signal is greater than or equal to the threshold value, estimate at least one non-linear signal coefficient for the signal obtained by attenuating the estimated self-interference signal from the frequency axis digital reception signal; and
in case that the strength of the signal obtained by attenuating the estimated self-interference signal from the frequency axis digital reception signal is less than the threshold value, estimate the self-interference signal, based on the estimated self-interference channel and the updated non-linear signal coefficient and perform the digital self-interference cancellation for the frequency axis digital reception signal by using the estimated self-interference signal.

14. The transmission/reception apparatus of claim 11, wherein the controller is further configured to:
compare a strength of a signal obtained by attenuating the estimated self-interference signal from the frequency axis digital reception signal with a threshold value;
in case that the strength of the signal obtained by attenuating the estimated self-interference signal from the frequency axis digital reception signal is greater than or equal to the threshold value, adjust a number of the non-linear signal coefficients and estimating the self-interference signal, based on the adjusted number of the non-linear signal coefficients; and
in case that the strength of the signal obtained by attenuating the estimated self-interference signal from the frequency axis digital reception signal is less than the threshold value, perform the digital self-interference cancellation for the frequency axis digital reception signal by using the estimated self-interference signal.

15. The transmission/reception apparatus of claim 11, wherein the controller is further configured to:
correct a time synchronization error for the time axis digital transmission signal.

16. The transmission/reception apparatus of claim 15, wherein the controller is further configured to:
configure an initial value of a time offset as 0;
convert the reception signal into a time axis digital reception signal;
perform a convolution operation for signals delayed from the time axis digital reception signal and the time axis digital transmission signal by the time offset;
compare a result of the convolution operation for the signals delayed from the time axis digital reception signal and the time axis digital transmission signal by the time offset with a result of the convolution operation for signals delayed from the time axis digital reception signal and the time axis digital transmission signal by a value less than the time offset by 1;
in case that the result of the convolution operation for the signals delayed from the time axis digital reception signal and the time axis digital transmission signal by the time offset is greater than the result of the convolution operation for signals delayed from the time axis digital reception signal and the time axis digital transmission signal by the value less than the time offset by 1, increase the time offset by 1 and compare a result of the convolution operation for signals delayed from the time axis digital reception signal and the time axis digital transmission signal by a value increased from the time offset by 1 with a result of the convolution operation for signals delayed from the time axis digital reception signal and the time axis digital transmission signal by the time offset; and
in case that the result of the convolution operation for the signals delayed from the time axis digital reception signal and the time axis digital transmission signal by the time offset is less than the result of the convolution operation for signals delayed from the time axis digital reception signal and the time axis digital transmission signal by the value less than the time offset by 1, configure the value less than the time offset by 1 as a time synchronization error value and correct the time synchronization error for the time axis digital transmission signal by using the configured time synchronization error value.

17. The transmission/reception apparatus of claim 15, wherein the controller is further configured to:
configure an initial value of a time offset as 0;
convert the reception signal into a time axis digital reception signal;
perform a convolution operation for signals delayed from the time axis digital reception signal and the time axis digital transmission signal by the time offset;
store a result of the convolution operation for the signals delayed from the time axis digital reception signal and the time axis digital transmission signal by the time offset;
compare the time offset and a value corresponding to a total number of samples for the time axis digital transmission signal;
in case that the time offset is less than the value corresponding to the total number of samples for the time axis digital transmission signal, increase the time offset by 1, perform the convolution operation for signals delayed from the time axis digital reception signal and the time axis digital transmission signal by a value increased from the time offset by 1, and store a result of the convolution operation for the signals delayed from the time axis digital reception signal and the time axis digital transmission signal by the value increased from the time offset by 1; and
in case that the time offset is greater than the value corresponding to the total number of samples for the time axis digital transmission signal, configure a time offset value corresponding to an operation result having a maximum value among stored at least one operation result as a time synchronization error value and correct the time synchronization error for the time axis digital transmission signal by using the configured time synchronization error value.

18. The transmission/reception apparatus of claim 11, wherein the controller is further configured to:
determine whether a time synchronization signal is included in the reception signal;
in case that the time synchronization signal is included in the reception signal, correct a time synchronization error of the reception signal by using the time synchronization signal; and
in case that the time synchronization signal is not included in the reception signal, correct the time synchronization error of the reception signal by using a data signal included in the reception signal.

19. The transmission/reception apparatus of claim 11, wherein the controller is further configured to:
convert the reception signal into a time axis digital reception signal;
approximate the time axis digital reception signal as a polynomial for the time axis digital transmission signal; and
configure respective terms of the approximated polynomial as the at least one time axis non-linear signal samples.

20. The transmission/reception apparatus of claim 11, wherein the controller is further configured to, in case that the frequency axis digital reception signal is approximated as a polynomial for the frequency axis digital transmission signal, correlate the non-linear coefficients to at least one term of the approximated polynomial.
